(19) United States
(12) Patent Application Publication
(10) Pub. No.: US 2026/0206028 A1
(43) Pub. Date: Jul. 16, 2026

(54) COMBINED REGIONS FOR CONTROL INFORMATION MONITORING

(71) Applicant: QUALCOMM Incorporated, San Diego, CA (US)

(72) Inventors: Gabi SARKIS, San Diego, CA (US); Le LIU, San Jose, CA (US); Mostafa KHOSHNEVISAN, San Diego, CA (US); Morteza SOLTANI, San Diego, CA (US); Weimin DUAN, San Diego, CA (US); Diana MAAMARI, San Diego, CA (US)

(21) Appl. No.: 19/020,221

(22) Filed: Jan. 14, 2025

(51) Int. Cl. H04W 72/23; H04W 24/08

(52) U.S. Cl. CPC H04W 72/23; H04W 24/08

(57) ABSTRACT

Various aspects of the present disclosure generally relate to wireless communication. In some aspects, a user equipment (UE) may receive a control configuration that indicates one or more control regions associated with an aggregate control region and that indicates a quantity of the one or more control regions associated with the aggregate control region. The UE may monitor, via the aggregate control region, for a downlink control transmission that is rate-matched over the one or more control regions. Numerous other aspects are described.

### FIELD OF THE DISCLOSURE

Aspects of the present disclosure generally relate to wireless communication and specifically relate to techniques, apparatuses, and methods associated with combined regions for control information monitoring.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

A network node may communicate control information with a user equipment (UE) via a control channel, such as a physical downlink control channel (PDCCH). The UE may monitor a control region for the control information from the network node. For example, the UE may be configured with and/or the network node may indicate a PDCCH monitoring region via which the UE may monitor for a PDCCH message.

A monitoring region may include and/or indicate a set of time-frequency resources, such as a control resource set (CORESET), a starting symbol of the monitoring region, and/or a periodicity of the monitoring region. The starting symbol of the monitoring region, and/or the periodicity of the monitoring region may be part of and/or may be indicated by a search space. As a result, CORESETs and/or search spaces may indicate and/or define a region via which a UE may monitor for and/or receive control information via a control channel.

### SUMMARY

Some aspects described herein relate to an apparatus for wireless communication at a user equipment (UE). The apparatus may include one or more memories and one or more processors coupled to the one or more memories. The one or more processors may be configured to receive a control configuration that indicates one or more control regions associated with an aggregate control region and that indicates a quantity of the one or more control regions associated with the aggregate control region. The one or more processors may be configured to monitor, via the aggregate control region, for a downlink control transmission that is rate-matched over the one or more control regions.

Some aspects described herein relate to an apparatus for wireless communication at a network node. The apparatus may include one or more memories and one or more processors coupled to the one or more memories. The one or more processors may be configured to transmit a control configuration that indicates one or more control regions associated with an aggregate control region and that indicates a quantity of the one or more control regions associated with the aggregate control region. The one or more processors may be configured to transmit, via the aggregate control region, a downlink control transmission that is rate-matched over the one or more control regions.

Some aspects described herein relate to a method of wireless communication performed by a UE. The method may include receiving a control configuration that indicates one or more control regions associated with an aggregate control region and that indicates a quantity of the one or more control regions associated with the aggregate control region. The method may include monitoring, via the aggregate control region, for a downlink control transmission that is rate-matched over the one or more control regions.

Some aspects described herein relate to a method of wireless communication performed by a network node. The method may include transmitting a control configuration that indicates one or more control regions associated with an aggregate control region and that indicates a quantity of the one or more control regions associated with the aggregate control region. The method may include transmitting, via the aggregate control region, a downlink control transmission that is rate-matched over the one or more control regions.

Some aspects described herein relate to a non-transitory computer-readable medium that stores a set of instructions for wireless communication by a UE. The set of instructions, when executed by one or more processors of the UE, may cause the UE to receive a control configuration that indicates one or more control regions associated with an aggregate control region and that indicates a quantity of the one or more control regions associated with the aggregate control region. The set of instructions, when executed by one or more processors of the UE, may cause the UE to monitor, via the aggregate control region, for a downlink control transmission that is rate-matched over the one or more control regions.

Some aspects described herein relate to a non-transitory computer-readable medium that stores a set of instructions for wireless communication by a network node. The set of instructions, when executed by one or more processors of the network node, may cause the network node to transmit a control configuration that indicates one or more control regions associated with an aggregate control region and that indicates a quantity of the one or more control regions associated with the aggregate control region. The set of instructions, when executed by one or more processors of the network node, may cause the network node to transmit, via the aggregate control region, a downlink control transmission that is rate-matched over the one or more control regions.

Some aspects described herein relate to an apparatus for wireless communication. The apparatus may include means for receiving a control configuration that indicates one or more control regions associated with an aggregate control region and that indicates a quantity of the one or more control regions associated with the aggregate control region. The apparatus may include means for monitoring, via the aggregate control region, for a downlink control transmission that is rate-matched over the one or more control regions.

Some aspects described herein relate to an apparatus for wireless communication. The apparatus may include means for transmitting a control configuration that indicates one or more control regions associated with an aggregate control region and that indicates a quantity of the one or more control regions associated with the aggregate control region. The apparatus may include means for transmitting, via the aggregate control region, a downlink control transmission that is rate-matched over the one or more control regions.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example of physical channels and reference signals in a wireless network, in accordance with the present disclosure.

FIG. 4 is a diagram illustrating an example resource structure for wireless communication, in accordance with the present disclosure.

FIG. 5 is a diagram illustrating examples of carrier aggregation, in accordance with the present disclosure

FIG. 6 is a diagram illustrating an example of a region for control information monitoring, in accordance with the present disclosure.

FIG. 7 is a diagram of an example associated with combined regions for control information monitoring, in accordance with the present disclosure.

FIG. 8A is a diagram illustrating an example of a combined region for control information monitoring, in accordance with the present disclosure.

FIG. 8B is a diagram illustrating an example of a combined region for control information monitoring, in accordance with the present disclosure.

FIG. 9 is a diagram illustrating an example process performed, for example, at a user equipment (UE) or an apparatus of a UE, in accordance with the present disclosure.

FIG. 10 is a diagram illustrating an example process performed, for example, at a network node or an apparatus of a network node, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A network node may communicate control information with a user equipment (UE) via a control channel, such as a physical downlink control channel (PDCCH). The UE may monitor a control region (e.g., a potential control region) for the control information from the network node. For example, the UE may be configured with and/or the network node may indicate a PDCCH monitoring region via which the UE may monitor for a PDCCH message.

A monitoring region may include and/or indicate a set of time-frequency resources, such as a control resource set (CORESET), a starting symbol of the monitoring region, and/or a periodicity of the monitoring region. The starting symbol of the monitoring region, and/or the periodicity of the monitoring region may be part of and/or may be indicated by a search space. As a result, CORESETs and/or search spaces may indicate and/or define a region via which a UE may monitor for and/or receive control information via a control channel.

A time resource, such as a symbol, that includes the CORESET may include one or more control channel elements (CCEs). A CCE may include downlink control information (DCI) that is used to provide control information for wireless communication. The network node may transmit DCI during multiple CCEs, where the quantity of CCEs used for transmission of DCI is related to an aggregation level used by the network node for the transmission of DCI. Carrier aggregation may enable two or more component carriers to be combined (e.g., into a single channel) for a single UE to increase data capacity. Different aggregation levels may be used, such as 1, 2, 4, 8, 16, (e.g., aggregating 1, 2, 4, 8, 16 component carriers respectively) and/or another aggregation level.

A search space may include all possible locations (e.g., in time and/or frequency) where a PDCCH may be located. A CORESET may include one or more search spaces, such as a UE-specific search space, a group-common search space, and/or a common search space. A search space may indicate a set of CCE locations where a UE may find PDCCHs that can potentially be used to transmit control information to the UE. The possible locations for a PDCCH may depend on whether the PDCCH is a UE-specific PDCCH (e.g., for a single UE) or a group-common PDCCH (e.g., for multiple UEs) and/or an aggregation level being used. A possible location (e.g., in time and/or frequency) for a PDCCH may be referred to as a PDCCH candidate, and the set of all possible PDCCH locations at an aggregation level may be referred to as a search space. For example, the set of all possible PDCCH locations for a particular UE may be referred to as a UE-specific search space. Similarly, the set of all possible PDCCH locations across all UEs may be referred to as a common search space. The set of all possible PDCCH locations for a particular group of UEs may be referred to as a group-common search space. One or more search spaces across aggregation levels may be referred to as a search space set.

Some wireless communication systems may define a largest total CORESET duration, which may include and/or indicate a quantity of time resources (e.g., three symbols). The quantity of time resources in a CORESET duration may include any quantity of time resources up to and including the largest quantity of time resources in a largest total CORESET duration. In some examples, largest total CORESET duration may be insufficient (e.g., may not include sufficient control resources) for scheduling each UE that is configured with the CORESET, which may lead to blocking (e.g., one UE communicating and another UE being prevented from communicating via the CORESET) and/or communication errors. As a result, the quantity of UEs that can be scheduled may be limited by the control resources. For coverage-limited scenarios, large aggregation levels may be used to schedule each UE in the system. For example, a smaller control region may provide sufficient resources for large aggregation-level PDCCHs, however may increase latency, complexity, communication errors, and/or overhead.

To increase control information capacity, the largest total CORESET duration, may be increased (e.g., increased to 14 symbols)—however, an increase in largest CORESET duration may increase complexity of the wireless communication system (e.g., causing excessive consumption of resources by each device associated with the wireless communication system) and/or may increase complexity at the UE because each duration possibility may use a unique configuration to scale for the larger duration of the CORESET.

Various aspects relate generally to combining control regions for control information monitoring. Some aspects more specifically relate to configuring a relatively larger control region using a configuration associated with a relatively smaller control region. For example, a UE may receive a control configuration (e.g., a configuration including control information, and/or communicated via control signaling), such as a search space configuration, that indicates an aggregate control region that includes a set of one or more constituent control regions. The constituent control region may include one or more unique constituent regions and/or may include a quantity of repeated instances of a constituent control region including a PDCCH that is rate-matched over the aggregate control region. As a result, the UE may monitor for control information that is rate-matched across the aggregate control region.

In some aspects, the constituent control channels may be in a same time resource and/or may be in two or more time resources. In some aspects, the constituent control regions may be consecutive in time and/or may be separated in time. In some aspects, constituent control regions that occur in different time resources may include a PDCCH candidate that is on a same frequency resource in each constituent control region and/or may include one or more PDCCH candidates that are in different frequency resources in each constituent control region.

Particular aspects of the subject matter described in this disclosure can be implemented to realize one or more of the following potential advantages. In some examples, the described techniques can be used to increase coverage, and in some examples, without significantly increasing complexity and/or by increasing complexity relatively little compared to other techniques that may increase coverage. For example, by monitoring, via the aggregate control region, for a downlink control transmission that is rate-matched over the one or more control regions, the UE may monitor for more control information and/or may potentially receive control information without being blocked by another UE. The various constituent control channel configurations described herein may each contribute benefits to various scenarios. For example, preconfiguring the constituent control region configuration may decrease overhead but dynamically indicating the constituent control region configuration may increase flexibility and adaptability to various wireless communication scenarios.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

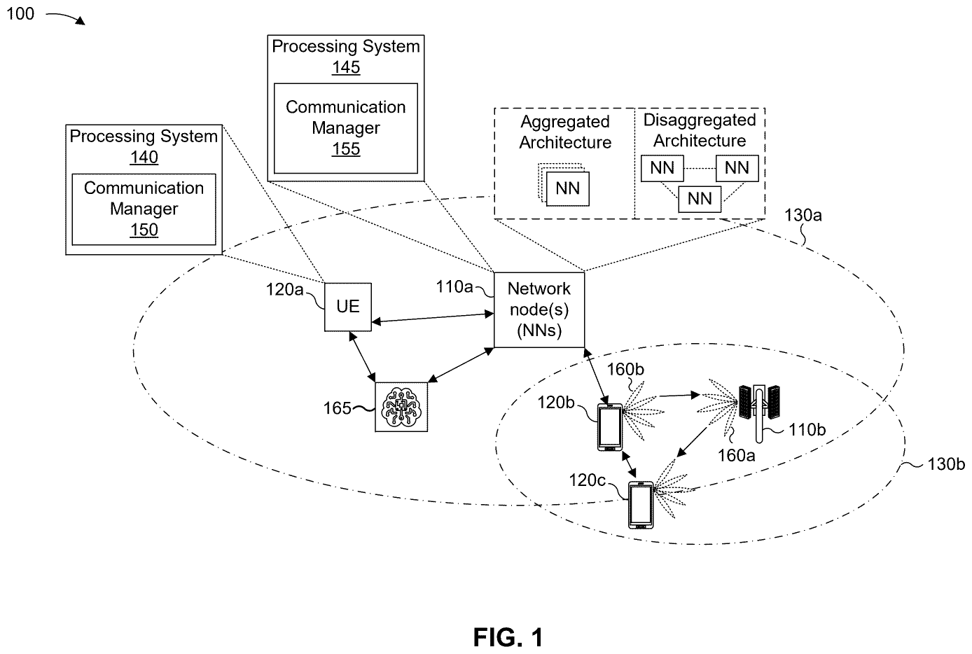

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

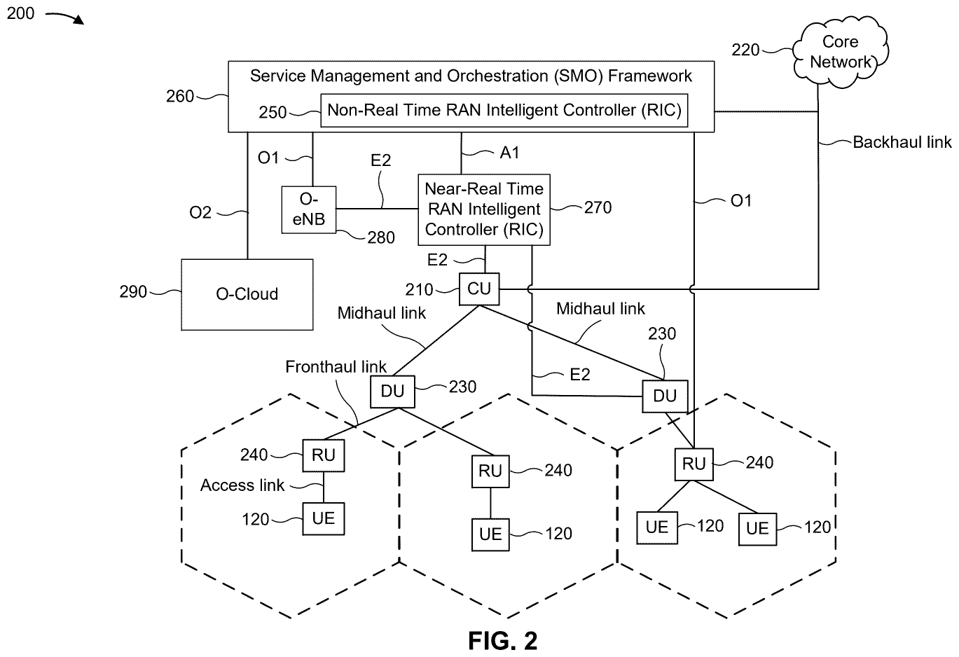

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a DCI configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include PDCCHs, and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, one or more network nodes 110, one or more UEs 120, and/or one or more servers, and/or one or more components of a cloud computing network, among other examples). For example, in an deployment where AI/ML functionality is performed independently at a device 165, sometimes referred to as “overlay AI/ML”, the AI/ML model (or an instance or portion of the AI/ML model) may be deployed at a UE 120 (for example, at the processing system 140), a network node 110 (for example, at the processing system 145), one or more servers, and/or one or more components of a cloud computing network, among other examples. Additionally or alternatively, in a deployment where AI/ML functionality is coordinated between different devices 165, sometimes referred to as “coordinated AI/ML”, or performed at all device and network layers, sometimes referred to as “native AI/ML”, the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML and/or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, and/or efficient use of network bandwidth, and/or to reduce latency, among other examples). For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, and/or traffic prediction, among other examples. In some examples, AI-as-a-Service use cases may include measurement collection reporting by a UE 120, device selection criteria (for example, according to a geographical area where measurements are to be collected and/or UE capabilities to be used to collected measurements), and/or reporting configurations (for example, reporting parameters such as location, time, and/or sensor information, among other examples). Additionally or alternatively, the AI/ML model(s) may enable AI/ML procedures (for example, RAN-triggered service establishment, configuration, inferencing using UE-side and/or network-side models, performance monitoring and/or management, and/or capability signaling, among other examples). Additionally or alternatively, the AI/ML model(s) may enable RAN-based AI/ML services via one or more application program interfaces (APIs) and/or management interfaces for use cases such as beam management, radio resource monitoring (RRM) relaxation, mobility prediction, load prediction, network energy savings, and/or coverage and capacity improvements, among other examples.

In some aspects, the UE 120 may include a communication manager 150. As described in more detail elsewhere herein, the communication manager 150 may receive a control configuration that indicates one or more control regions associated with an aggregate control region and that indicates a quantity of the one or more control regions associated with the aggregate control region; and monitor, via the aggregate control region, for a downlink control transmission that is rate-matched over the one or more control regions. Additionally, or alternatively, the communication manager 150 may perform one or more other operations described herein.

In some aspects, the network node 110 may include a communication manager 155. As described in more detail elsewhere herein, the communication manager 155 may transmit a control configuration that indicates one or more control regions associated with an aggregate control region and that indicates a quantity of the one or more control regions associated with the aggregate control region; and transmit, via the aggregate control region, a downlink control transmission that is rate-matched over the one or more control regions. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

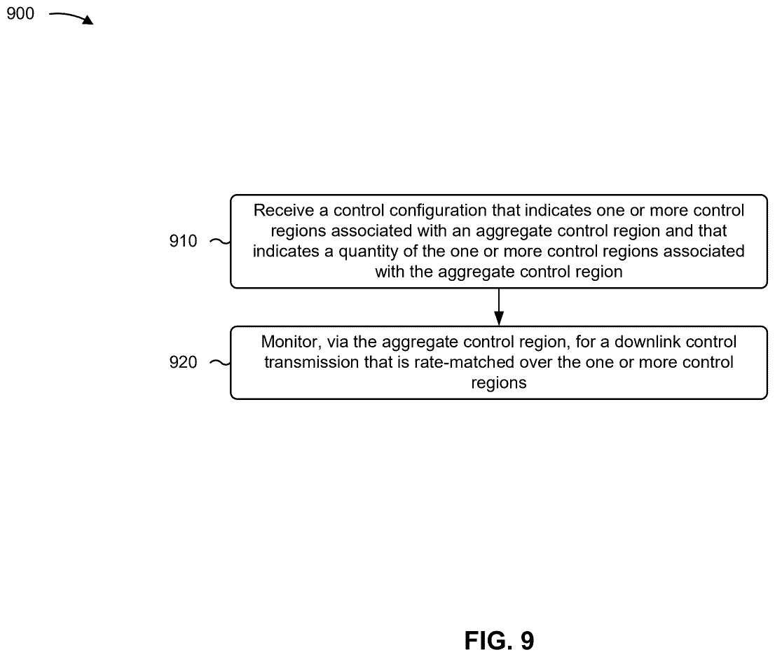

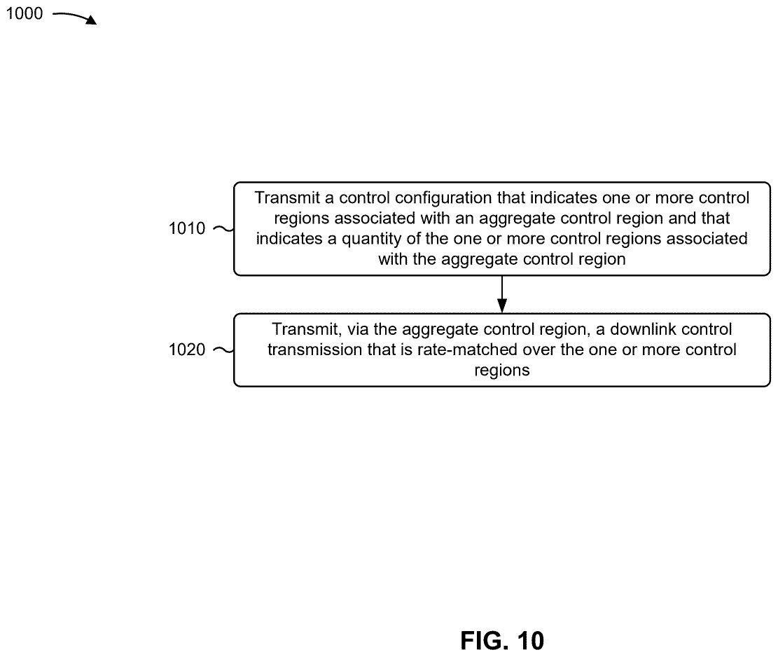

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with combined control regions for control information monitoring, as described in more detail elsewhere herein. For example, the processing system 145 of the network node 110, the processing system 140 of the UE 120, the CU 210, the DU 230, or the RU 240 may perform or direct operations of, for example, process 900 of FIG. 9, process 1000 of FIG. 10, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 900 of FIG. 9, process 1000 of FIG. 10, or other processes as described herein. In some examples, executing instructions may include running the instructions, converting the instructions, compiling the instructions, and/or interpreting the instructions, among other examples.

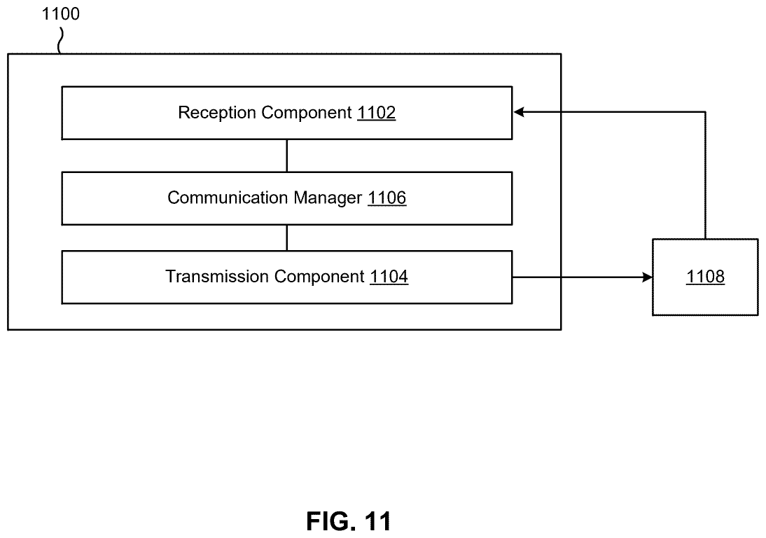

In some aspects, the UE 120 includes means for receiving a control configuration that indicates one or more control regions associated with an aggregate control region and that indicates a quantity of the one or more control regions associated with the aggregate control region; and/or means for monitoring, via the aggregate control region, for a downlink control transmission that is rate-matched over the one or more control regions. The means for the UE 120 to perform operations described herein may include, for example, one or more of communication manager 150, processing system 140, a radio, one or more RF chains, one or more transceivers, one or more antennas, one or more modems, a reception component (for example, reception component 1102 depicted and described in connection with FIG. 11), and/or a transmission component (for example, transmission component 1104 depicted and described in connection with FIG. 11), among other examples.

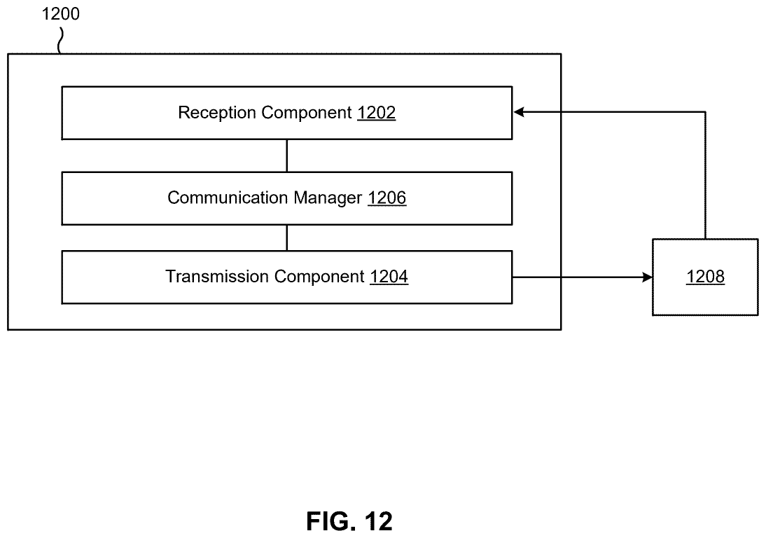

In some aspects, the network node 110 includes means for transmitting a control configuration that indicates one or more control regions associated with an aggregate control region and that indicates a quantity of the one or more control regions associated with the aggregate control region; and/or means for transmitting, via the aggregate control region, a downlink control transmission that is rate-matched over the one or more control regions. The means for the network node 110 to perform operations described herein may include, for example, one or more of communication manager 155, processing system 145, a radio, one or more RF chains, one or more transceivers, one or more antennas, one or more modems, a reception component (for example, reception component 1202 depicted and described in connection with FIG. 12), and/or a transmission component (for example, transmission component 1204 depicted and described in connection with FIG. 12, among other examples).

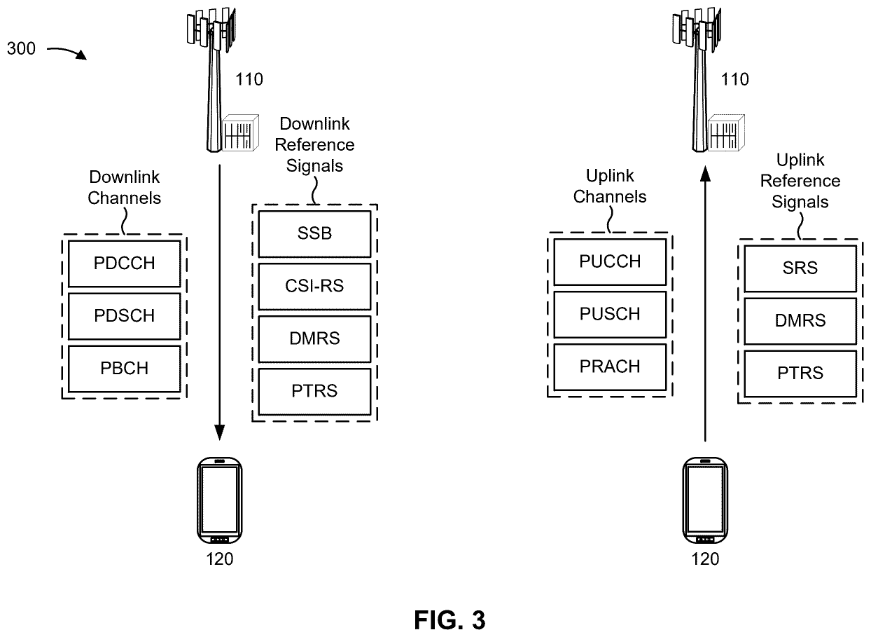

FIG. 3 is a diagram illustrating an example 300 of physical channels and reference signals in a wireless network, in accordance with the present disclosure. As shown in FIG. 3, downlink channels and downlink reference signals may carry information from a network node 110 to a UE 120, and uplink channels and uplink reference signals may carry information from a UE 120 to a network node 110.

As shown, a downlink channel may include a PDCCH that carries DCI, a PDSCH that carries downlink data, or a physical broadcast channel (PBCH) that carries system information, among other examples. In some aspects, PDSCH communications may be scheduled by PDCCH communications. As further shown, an uplink channel may include a physical uplink control channel (PUCCH) that carries uplink control information (UCI), a physical uplink shared channel (PUSCH) that carries uplink data, or a physical random access channel (PRACH) used for initial network access, among other examples. In some aspects, the UE 120 may transmit acknowledgement (ACK) or negative acknowledgement (NACK) feedback (e.g., ACK/NACK feedback or ACK/NACK information) in UCI on the PUCCH and/or the PUSCH.

As further shown, a downlink reference signal may include a synchronization signal block (SSB), a channel state information (CSI) reference signal (CSI-RS), a demodulation reference signal (DMRS), a positioning reference signal (PRS), or a phase tracking reference signal (PTRS), among other examples. As also shown, an uplink reference signal may include a sounding reference signal (SRS), a DMRS, or a PTRS, among other examples.

An SSB may carry information used for initial network acquisition and synchronization, such as a primary synchronization signal (PSS), a secondary synchronization signal (SSS), a PBCH, and a PBCH DMRS. An SSB is sometimes referred to as a synchronization signal/PBCH (SS/PBCH) block. In some aspects, the network node 110 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. The network node 110 may configure a set of CSI-RSs for the UE 120, and the UE 120 may measure the configured set of CSI-RSs. Based at least in part on the measurements, the UE 120 may perform channel estimation and may report channel estimation parameters to the network node 110 (e.g., in a CSI report), such as a channel quality indicator (CQI), a precoding matrix indicator (PMI), a CSI-RS resource indicator (CRI), a layer indicator (LI), a rank indicator (RI), or a reference signal received power (RSRP), among other examples. The network node 110 may use the CSI report to select transmission parameters for downlink communications to the UE 120, such as a number of transmission layers (e.g., a rank), a precoding matrix (e.g., a precoder), a modulation and coding scheme (MCS), or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS may carry information used to compensate for oscillator phase noise. Typically, the phase noise increases as the oscillator carrier frequency increases. Thus, PTRS can be utilized at high carrier frequencies, such as millimeter wave frequencies, to mitigate phase noise. The PTRS may be used to track the phase of the local oscillator and to enable suppression of phase noise and common phase error (CPE). As shown, PTRSs are used for both downlink communications (e.g., on the PDSCH) and uplink communications (e.g., on the PUSCH).

A PRS may carry information used to enable timing or ranging measurements of the UE 120 based on signals transmitted by the network node 110 to improve observed time difference of arrival (OTDOA) positioning performance. For example, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). In general, a PRS may be designed to improve detectability by the UE 120, which may need to detect downlink signals from multiple neighboring network nodes in order to perform OTDOA-based positioning. Accordingly, the UE 120 may receive a PRS from multiple cells (e.g., a reference cell and one or more neighbor cells), and may report a reference signal time difference (RSTD) based on OTDOA measurements associated with the PRSs received from the multiple cells. In some aspects, the network node 110 may then calculate a position of the UE 120 based on the RSTD measurements reported by the UE 120.

An SRS may carry information used for uplink channel estimation, which may be used for scheduling, link adaptation, precoder selection, or beam management, among other examples. The network node 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, uplink beam management, among other examples. The network node 110 may measure the SRSs, may perform channel estimation based at least in part on the measurements, and may use the SRS measurements to configure communications with the UE 120.

The UE 120 may monitor a set of control resources for a PDCCH message. The set of control resources may correspond to a network node 110 that is in communication with a set of UEs 120. The set of UEs 120 may each monitor the set of control resources for DCI via PDCCH from the network node 110. In some examples, the set of control resources may be sufficient for a quantity of UEs 120 that is less than the quantity of UEs 120 in communication with the network node 110. For example, the set of control resources may support unblocked scheduling for a limited quantity of UEs 120.

As indicated above, FIG. 3 is provided as an example. Other examples may differ from what is described with regard to FIG. 3.

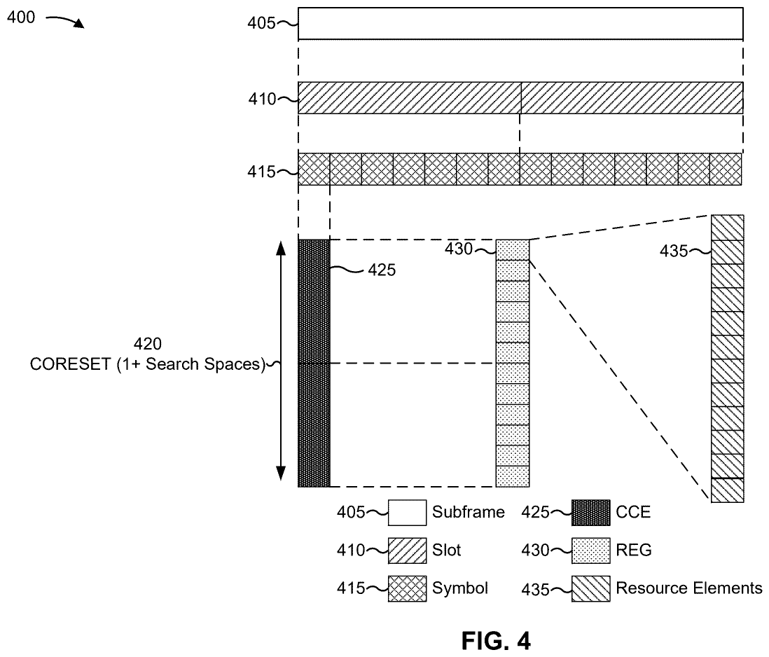

FIG. 4 is a diagram illustrating an example resource structure 400 for wireless communication, in accordance with the present disclosure. Resource structure 400 shows an example of various groups of resources described herein. As shown, resource structure 400 may include a subframe 405. Subframe 405 may include multiple slots 410. While resource structure 400 is shown as including 2 slots per subframe, a different number of slots may be included in a subframe (e.g., 4 slots, 8 slots, 16 slots, 32 slots, or another quantity of slots). In some aspects, different types of transmission time intervals (TTIs) may be used, other than subframes and/or slots. A slot 410 may include multiple symbols 415, such as 14 symbols per slot.

The potential control region of a slot 410 may be referred to as a CORESET 420 and may be structured to support an efficient use of resources, such as by flexible configuration or reconfiguration of resources of the CORESET 420 for one or more PDCCHs and/or one or more PDSCHs. In some aspects, the CORESET 420 may occupy the first symbol 415 of a slot 410, the first two symbols 415 of a slot 410, or the first three symbols 415 of a slot 410. Thus, a CORESET 420 may include multiple resource blocks (RBs) in the frequency domain, and either one, two, or three symbols 415 in the time domain. In 5G, a quantity of resources included in the CORESET 420 may be flexibly configured, such as by using RRC signaling to indicate a frequency domain region (e.g., a quantity of resource blocks) and/or a time domain region (e.g., a quantity of symbols) for the CORESET 420.

As illustrated, a symbol 415 that includes CORESET 420 may include one or more control channel elements (CCEs) 425, shown as two CCEs 425 as an example, that span a portion of the system bandwidth. A CCE 425 may include DCI that is used to provide control information for wireless communication. A network node may transmit DCI during multiple CCEs 425 (as shown), where the quantity of CCEs 425 used for transmission of DCI represents the aggregation level (AL) used by the BS for the transmission of DCI. In FIG. 4, an aggregation level of two is shown as an example, corresponding to two CCEs 425 in a slot 410. In some aspects, different aggregation levels may be used, such as 1, 2, 4, 8, 16, or another aggregation level.

Each CCE 425 may include a fixed quantity of resource element groups (REGs) 430, shown as 6 REGs 430, or may include a variable quantity of REGs 430. In some aspects, the quantity of REGs 430 included in a CCE 425 may be specified by a REG bundle size. A REG 430 may include one resource block, which may include 12 resource elements (REs) 435 within a symbol 415. A resource element 435 may occupy one subcarrier in the frequency domain and one OFDM symbol in the time domain.

A search space may include all possible locations (e.g., in time and/or frequency) where a PDCCH may be located. A CORESET 420 may include one or more search spaces, such as a UE-specific search space, a group-common search space, and/or a common search space. A search space may indicate a set of CCE locations where a UE may find PDCCHs that can potentially be used to transmit control information to the UE. The possible locations for a PDCCH may depend on whether the PDCCH is a UE-specific PDCCH (e.g., for a single UE) or a group-common PDCCH (e.g., for multiple UEs) and/or an aggregation level being used. A possible location (e.g., in time and/or frequency) for a PDCCH may be referred to as a PDCCH candidate, and the set of all possible PDCCH locations at an aggregation level may be referred to as a search space. For example, the set of all possible PDCCH locations for a particular UE may be referred to as a UE-specific search space. Similarly, the set of all possible PDCCH locations across all UEs may be referred to as a common search space. The set of all possible PDCCH locations for a particular group of UEs may be referred to as a group-common search space. One or more search spaces across aggregation levels may be referred to as a search space (SS) set.

A CORESET 420 may be interleaved or non-interleaved. An interleaved CORESET 420 may have CCE-to-REG mapping such that adjacent CCEs are mapped to scattered REG bundles in the frequency domain (e.g., adjacent CCEs are not mapped to consecutive REG bundles of the CORESET 420). A non-interleaved CORESET 420 may have a CCE-to-REG mapping such that all CCEs are mapped to consecutive REG bundles (e.g., in the frequency domain) of the CORESET 420.

Some wireless communications systems may define a largest total duration of the CORESET 420, which may include and/or indicate a quantity of time resources (e.g., three symbols). The quantity of time resources in the CORESET 420 may include any quantity of time resources up to and including the largest quantity of time resources in a largest total duration. In some examples, largest total duration may be insufficient (e.g., may not include sufficient control resources) for scheduling each UE that is configured with the CORESET 420 and/or that is in communication with a network node communicating via the CORESET 420, which may lead to blocking (e.g., one UE communicating and another UE being prevented from communicating via the CORESET) and/or communication errors. As a result, the quantity of UEs that can be scheduled may be limited by the control resources.

To increase control information capacity, the largest total duration of the CORESET 420 may be increased (e.g., increased to 14 symbols)—however, an increase in the largest duration may increase complexity of the wireless communication system (e.g., causing excessive consumption of resources by each device associated with the wireless communication system) and/or may increase complexity at the UE because each duration possibility may use a unique configuration to scale for the larger duration of the CORESET 420.

As indicated above, FIG. 4 is provided as an example. Other examples may differ from what is described with respect to FIG. 4.

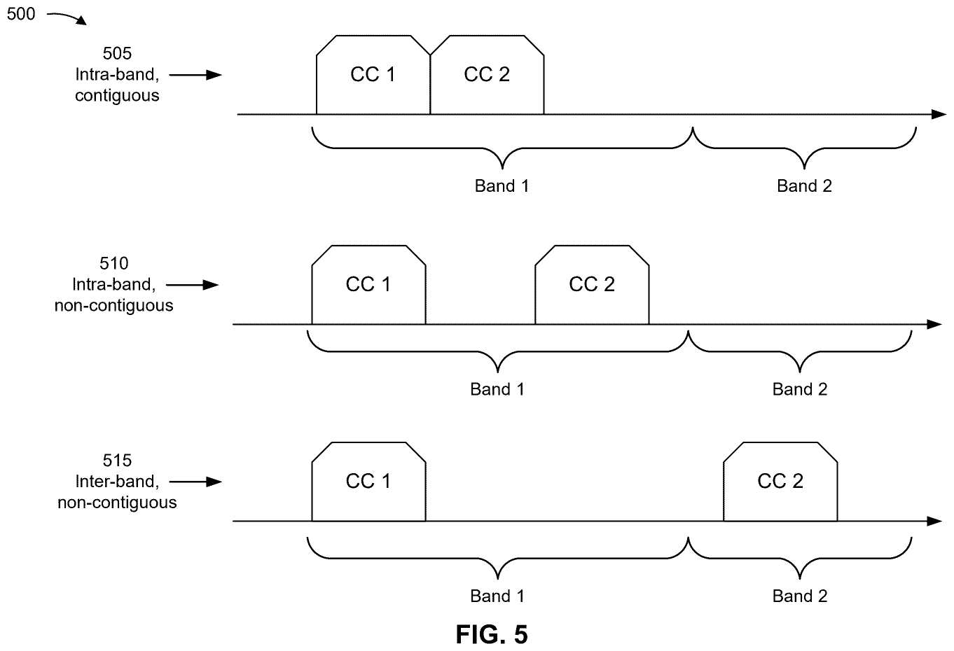

FIG. 5 is a diagram illustrating examples 500 of carrier aggregation, in accordance with the present disclosure.

Carrier aggregation is a technology that enables two or more component carriers (CCs, sometimes referred to as carriers) to be combined (e.g., into a single channel) for a single UE 120 to enhance data capacity. As shown, carriers can be combined in the same or different frequency bands. Additionally, or alternatively, contiguous or non-contiguous carriers can be combined. A network node 110 may configure carrier aggregation for a UE 120, such as in an RRC message, DCI, and/or another signaling message.

As shown by reference number 505, in some aspects, carrier aggregation may be configured in an intra-band contiguous mode where the aggregated carriers are contiguous to one another and are in the same band. As shown by reference number 510, in some aspects, carrier aggregation may be configured in an intra-band non-contiguous mode where the aggregated carriers are non-contiguous to one another and are in the same band. As shown by reference number 515, in some aspects, carrier aggregation may be configured in an inter-band non-contiguous mode where the aggregated carriers are non-contiguous to one another and are in different bands.

In carrier aggregation, a UE 120 may be configured with a primary carrier or primary cell (PCell) and one or more secondary carriers or secondary cells (SCells). In some aspects, the primary carrier may carry control information (e.g., downlink control information and/or scheduling information) for scheduling data communications on one or more secondary carriers, which may be referred to as cross-carrier scheduling. In some aspects, a carrier (e.g., a primary carrier or a secondary carrier) may carry control information for scheduling data communications on the carrier, which may be referred to as self-carrier scheduling or carrier self-scheduling.

In some coverage-limited scenarios, large aggregation levels may be used to schedule each UE in communication with a network node. For example, a smaller control region may provide sufficient resources for large aggregation-level PDCCHs. However relying on large aggregation levels to increase control information throughput and coverage may increase latency, complexity, communication errors, and/or overhead.

As indicated above, FIG. 5 is provided as an example. Other examples may differ from what is described with regard to FIG. 5.

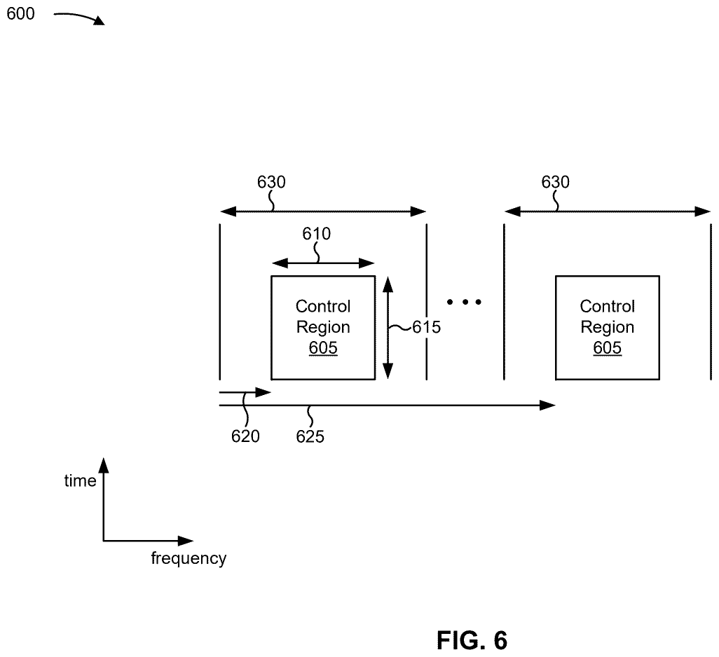

FIG. 6 is a diagram illustrating an example 600 of a region for control information monitoring, in accordance with the present disclosure. As shown in FIG. 6, the example 600 may include a control region 605.

A network node (e.g., network node 110 described in connection with FIGS. 1-5) may communicate control information with a UE (e.g., UE 120 described in connection with FIGS. 1-5) via a control channel, such as a PDCCH. The UE may monitor a control region for the control information from the network node. For example, the UE may be configured with and/or the network node may indicate a PDCCH monitoring region via which the UE may monitor for a PDCCH message.

A monitoring region may include and/or indicate a set of time-frequency resources, such as a control resource set (e.g., CORESET). The CORESET may be defined by a quantity of time resources, as shown by reference number 610, and a quantity of frequency resources, as shown by reference number 615. A search space may indicate to a UE a time-frequency location of a control region (e.g., as defined by a CORESET). The search space may include a starting symbol of the monitoring region, as shown by reference number 620, and/or a periodicity of the monitoring region, as shown by reference number 625. The starting symbol of the monitoring region (e.g., as shown by reference number 620), and/or the periodicity of the monitoring region (e.g., as shown by reference number 625) may be part of and/or may be indicated by a control configuration, such as a search space configuration. The control region 605 may be repeated via different symbols 630 as indicated by the periodicity shown by reference number 625. As a result, CORESETs and/or search spaces may indicate and/or define the control region 605 via which a UE may monitor for and/or receive control information via a control channel.

The control region 605 may be an example of a non-aggregated control region. Additionally or alternatively, the control region 605 may be an example of a control region including a PDCCH that is repeated via each instance of the control region 605 and linked via search spaces. For example, each control region 605 may be associated with a corresponding search space that is linked to the other search spaces including a PDCCH repetition.

As indicated above, FIG. 6 is provided as an example. Other examples may differ from what is described with respect to FIG. 6.

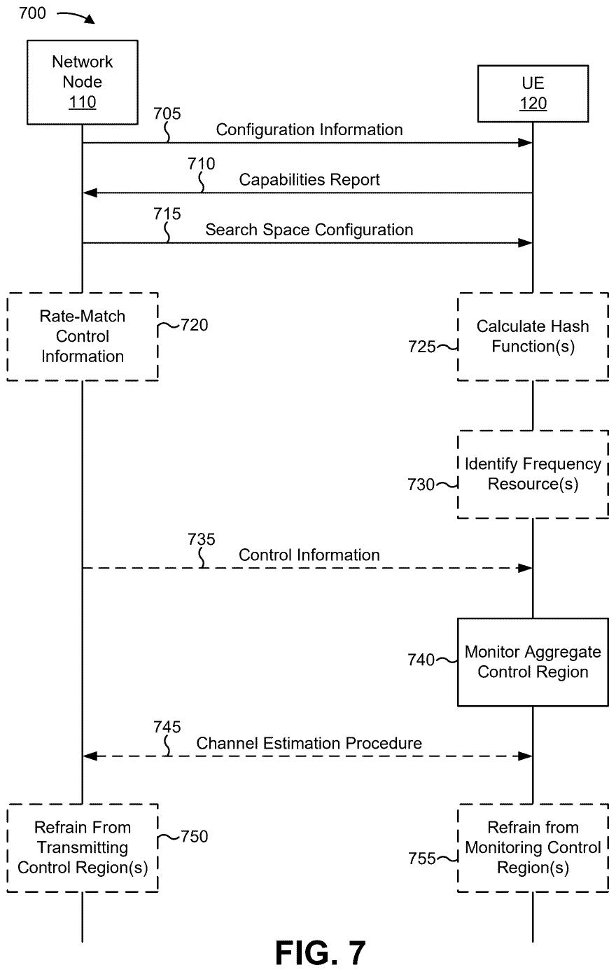

FIG. 7 is a diagram of an example 700 associated with combined regions for control information monitoring, in accordance with the present disclosure. As shown in FIG. 7, a network node 110 (e.g., network node 110 described in connection with FIGS. 1-6, a CU, a DU, and/or an RU) may communicate with a UE 120 (e.g., UE 120 described in connection with FIGS. 1-6). In some aspects, the network node 110 and the UE 120 may be part of a wireless network (e.g., wireless network 100). The UE 120 and the network node 110 may have established a wireless connection prior to operations shown in FIG. 7.

As shown by reference number 705, the network node 110 may transmit, and the UE 120 may receive, configuration information. In some aspects, the UE 120 may receive the configuration information via one or more of system information (e.g., a master information block (MIB) and/or a system information block (SIB), among other examples), RRC signaling, one or more medium access control (MAC) control elements (CEs), and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication (e.g., an indication described herein) may include a dynamic indication, such as one or more MAC CEs and/or one or more DCI messages, among other examples.

In some aspects, the configuration information may indicate that the UE 120 is to monitor a combined and/or aggregated control region. The UE 120 may configure itself based at least in part on the configuration information. In some aspects, the UE 120 may be configured to perform one or more operations described herein based at least in part on the configuration information. In some aspects, the configuration information may include a control configuration, such as a search space configuration, as will be described in connection with reference number 715.

As shown by reference number 710, the UE 120 may transmit, and the network node 110 may receive, a capabilities report. The capabilities report may indicate whether the UE 120 supports a feature and/or one or more parameters related to the feature. For example, the capability information may indicate a capability and/or parameter for monitoring a combined and/or aggregated control region. As another example, the capabilities report may indicate a capability and/or parameter for calculating a hash function associated with one or more control channel candidates associated with an aggregate control region. One or more operations described herein may be based on capability information of the capabilities report. For example, the UE 120 may perform a communication in accordance with the capability information, or may receive configuration information that is in accordance with the capability information. In some aspects, the capabilities report may indicate UE-support for monitoring various configurations of a combined and/or aggregated control region.

In some aspects, the configuration information described in connection with reference number 705 and/or the capabilities report described in connection with reference number 710 may include information transmitted via multiple communications. Additionally, or alternatively, the network node 110 may transmit the configuration information, or a communication including at least a portion of the configuration information, before and/or after the UE 120 transmits the capabilities report. For example, the network node 110 may transmit a first portion of the configuration information before the capabilities report, the UE 120 may transmit at least a portion of the capabilities report, and the network node 110 may transmit a second portion of the configuration information after receiving the capabilities report.

As shown by reference number 715, the network node 110 may transmit, and the UE 120 may receive, a control configuration, such as a search space configuration. For example, the network node 110 may transmit, and the UE 120 may receive a control configuration that indicates one or more control regions associated with an aggregate control region and that indicates a quantity of the one or more control regions associated with the aggregate control region. A control configuration may indicate a constituent control region (e.g., one or more control regions) and/or a quantity of instances the constituent control region is replicated (e.g., a quantity of the one or more control regions) to define a larger control region (e.g., the aggregate control region).

The quantity of the one or more control regions associated with the aggregate control region may include a quantity of instances of each control region of the one of more control regions. For example, the indicated quantity may include a quantity of instances of each constituent control region. Examples may include: a first quantity of a first constituent control region (e.g., and no other constituent control regions); a first quantity of a first constituent control region and a second quantity of a second constituent control region, among other examples. The indicated quantity may include multiple values (e.g., corresponding to multiple constituent control regions) and/or a single value (e.g., corresponding to a single constituent control region). In some aspects, the aggregated control region includes the one or more (e.g., constituent control regions). In some aspects, the one or more control regions may be contiguous in the time domain. In some other aspects, the control configuration may indicate a time gap between a first control region of the one or more control regions and a second control region of the one or more control regions. For example, the aggregate control region may include one or more constituent control regions that are separated in time (e.g., may be associated with an intervening time gap that is configured via the control configuration).

In some aspects, the quantity of the one or more control regions associated with the aggregate control region may include a total quantity of control regions. For example, the quantity of the one or more control regions may include an explicit indication (e.g., an indication of “two” in the example that the aggregate control region includes two constituents)and/or the quantity of the one or more control regions may include an implicit indication. For example, the control configuration described in connection with reference number 715 may indicate a first constituent control region and a second constituent control region and thus may implicitly indicate there are two total control regions in the aggregate control region.

In some aspects, the control configuration may include an aggregation indication that indicates whether control region aggregation is enabled and/or that indicates that the quantity of the one or more control regions associated with the aggregate control region includes more than one control region. In some aspects, each control region of the one or more control regions associated with the aggregate control region may be associated with a set of one or more time resources and a set of one or more frequency resources. For example, each constituent control region may include a quantity of resource elements. In some aspects, the control configuration may indicate an index associated with each control region of the one or more control regions associated with the aggregate control region.

In some aspects, the control configuration may indicate a firstly occurring time resource of a set of consecutive time resources that includes at least one control region of the one or more control regions. For example, when the control configuration defines the constituent control regions to be in different slots, the search space indication may additionally indicate which slot is the beginning slot of the resulting control region. In some other aspects, the control configuration may indicate a plurality of time resource indices corresponding to a set of time resources, and each time resource of the set of time resources may include at least one control region of the one or more control regions. For example, when the control configuration defines the constituent control regions to be in different slots, the search space indication may additionally indicate that the aggregate control region begins with a slot having an index that is a multiple of a fixed number and/or may indicate the resulting duration of the aggregate control region.

As shown by reference number 720, the network node 110 may rate-match control information over the aggregate control region. For example, the network node 110 may rate-match the downlink control transmission across a set of one or more control channel candidates.

As shown by reference number 725, the UE 120 may calculate one or more hash functions. In some aspects, the UE 120 may calculate, using a time resource index of a firstly occurring time resource of a plurality of time resources each including at least one control region of the one or more control regions, a hash function for a plurality of a control channel candidates corresponding to the aggregate control region. For example, the UE 120 may calculate a frequency location of each of the one of more control channel candidates using a slot index of the first slot including the aggregate control region such that each control channel candidate includes a same frequency location.

The UE 120 may calculate independently from a time resource index, a hash function for a plurality of a control channel candidates corresponding to the aggregate control region. For example, when the one or more constituent control regions are in different slots, the candidate frequency locations may be the same for each constituent region (e.g., and the UE 120 may not use the slot index as an input for identifying the frequency locations). In some other aspects, the UE 120 may use a hash function for each control channel candidate of a plurality of control channel candidates corresponding to the aggregate control region using a time resource index corresponding to each control channel candidate. In some other aspects, the control configuration described in connection with reference number 715 may indicate a set of frequency resources for each control region of the one or more control regions.

As shown by reference number 730, the UE 120 may identify one or more frequency resources associated with the aggregate control region. For example, the UE 120 may identify one or more frequency locations associated with one or more PDCCH candidates rate-matched over the one or more control regions.

As shown by reference number 735, the network node 110 may transmit, and the UE 120 may receive, control information. For example, the network node 110 may transmit, via the aggregate control region, a downlink control transmission that is rate-matched over the one or more control regions. The network node 110 may transmit the downlink control transmission according to any of the aggregate control region configurations described herein.

As shown by reference number 740, the UE 120 may monitor the aggregate control region for the control information. For example, the UE 120 may monitor, via the aggregate control region, for a downlink control transmission that is rate-matched over the one or more control regions. A downlink control transmission (e.g., PDCCH) may be rate-matched across the resulting larger control region (e.g., the one or more control regions, the aggregate control region). The downlink control transmission is associated with a set of one or more control channel candidates.

In some aspects, the UE 120 may monitor for the downlink control transmission during a time resource (e.g., a single time resource and/or slot). In such aspects, the time resource may include each of the one or more control regions. In some aspects, the UE 120 may monitor for the downlink control transmission during a first time resource and a second time resource. In such aspects, the first time resource and the second time resource may each include at least one control region of the one or more control regions. In some aspects, the UE 120 may monitor for the downlink control transmission during a first time resource and a second time resource. In such aspects, the first time resource and the second time resource may each include at least one control region of the one or more control regions, and at least one of the first time resource or the second time resource includes two or more control regions. For example, the constituent control regions may be in a same slot, in different slots, and/or some of the constituent control regions may be in a same slot while other constituent control regions are in a different slot.

In some aspects, the UE 120 may monitor, via a first frequency resource during a first time resource, for a first control channel candidate associated with a first control region of the one or more control regions, and the UE 120 may monitor, via the first frequency resource during a second time resource, for a second control channel candidate associated with a second control region of the one or more control regions. For example, the rate-matched PDCCH may be rate-matched over a same frequency location in multiple slots. In some other aspects, the UE 120 may monitor, via a first frequency resource during a first time resource, for a first control channel candidate associated with a first control region of the one or more control regions, and the UE 120 may monitor, via a second frequency resource during a second time resource, for a second control channel candidate associated with a second control region of the one or more control regions. For example, the rate-matched PDCCH may be rate-matched over different frequency locations in each slot.

In some aspects, the UE 120 may monitor, via a frequency resource during a time resource, for a first control channel candidate associated with a first control region of the one or more control regions, and for a second control channel candidate associated with a second control region of the one or more control regions. For example, the PDCCH candidate frequency locations may be the same for each constituent control region. In some other aspects, the UE 120 may monitor, via a first frequency resource during a time resource, for a first control channel candidate associated with a first control region of the one or more control regions, and the UE 120 may monitor, via a second frequency resource during the time resource, for a second control channel candidate associated with a second control region of the one or more control regions. For example, the PDCCH candidate frequency locations may be different for each constituent control region. In such aspects, the control configuration indicates the first frequency resource and the second frequency resource. In other such aspects, the calculating described in connection with reference number 725 may include calculating, using an index associated with the first control region, a hash function for the first control channel candidate that indicates the first frequency resource, and calculating, using an index associated with the second control region, a hash function for the second control channel candidate that indicates the second frequency resource. For example, the UE 120 may use the constituent region indices to calculate the PDCCH candidate locations. In some other such examples, the calculating described in connection with reference number 725 may include calculating, using an index associated with the first control region, a hash function for the first control channel candidate that indicates the first frequency resource, and the identifying described in connection with reference number 730 may include identifying the second frequency resource according to a frequency hopping factor applied to the first frequency resource.

As shown by reference number 745, the network node 110 and/or the UE 120 may perform a channel estimation procedure. In some aspects, the network node 110 and/or the UE 120 may perform a channel estimation procedure, where each control region is associated with a corresponding quantity of time-frequency resources, and a total quantity of time-frequency resources over which the UE is enabled to perform the channel estimation procedure is linearly correlated with the quantity of the one of more control regions. For example, a quantity of resources occupied by an aggregation level may increase with the quantity of the one or more constituent control regions and a maximum quantity of CCEs that the UE 120 is enabled to monitor increases with the quantity of constituent regions. In such aspects, the one or more control regions may be monitored via two or more time resources. In other such aspects, the one or more control regions may be monitored via a single time resource.

In some other aspects, the network node 110 and/or the UE 120 may perform a channel estimation procedure, where each control region is associated with a subset of a total quantity of time-frequency resources over which the UE is enabled to perform the channel estimation procedure, and the total quantity of time-frequency resources is fixed. For example, a quantity of resources occupied by an aggregation level may increase with the quantity of the one or more constituent control regions and a maximum quantity of CCEs that the UE 120 monitors does not increase with the number of constituent control regions. In such aspects, the one or more control regions may be associated with (and/or monitored via) a single time resource. In other such aspects, the one or more control regions may be monitored via two or more time resources.

As shown by reference number 750, the network node 110 may refrain from transmitting control information via one or more control regions. For example, the network node 110 may refrain from transmitting control regions associated one or more other aggregation levels.

As shown by reference number 755, the UE 120 may refrain from monitoring for control information via one or more control regions. In some aspects, the one or more control regions mb associated with the aggregate control region may be associated with an aggregation level, and the UE 120 may refrain from monitoring control regions associated with one or more other aggregation levels. For example, the quantity of resources occupied by an aggregation level may be independent of the quantity of constituent control regions. In such aspects, some aggregation levels may not be monitored when multiple constituent regions are combined. For example, the UE 120 may ignore candidates with these aggregation levels and/or the control configuration may not include candidates associated with these aggregation levels.

As indicated above, FIG. 7 is provided as an example. Other examples may differ from what is described with respect to FIG. 7.

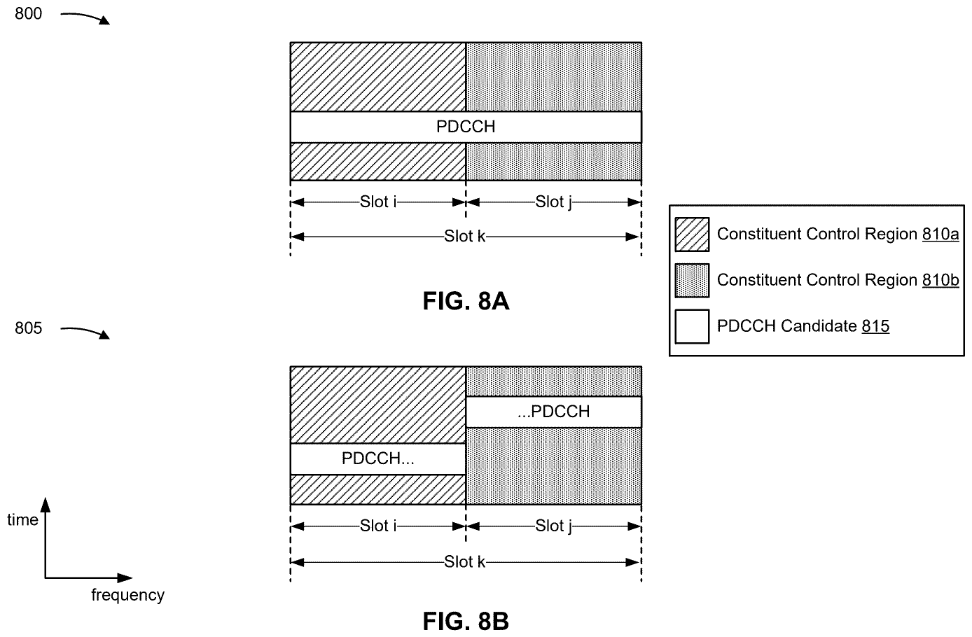

FIG. 8A is a diagram illustrating an example 800 of a combined region for control information monitoring, in accordance with the present disclosure. As shown in FIG. 8A, a network node 110 and a UE 120 may communicate with one another.

FIG. 8B is a diagram illustrating an example 805 of a combined region for control information monitoring, in accordance with the present disclosure. As shown in FIG. 8B, a network node 110 and a UE 120 may communicate with one another.

The examples 800 and/or 805 may each be defined and/or indicated by a control configuration, such as a search space configuration, that may indicate one or more constituent control regions 810 (e.g., one or more control regions) and/or a quantity of instances the constituent control region is replicated (e.g., a quantity of each of the one or more control regions) to define a larger control region (e.g., the aggregate control region). In some scenarios, the quantity of instances may include a maximum of two instances, and the aggregation may be alternatively indicated as whether aggregation is enabled. The examples 800 and 805 illustrate a first constituent control region 810a (e.g., defined by a duration and/or a frequency bandwidth) and a second constituent control region 810b (e.g., defined by a duration and/or a frequency bandwidth). A downlink control transmission may be rate-matched across the resulting aggregate control region.

In some aspects, the constituent control regions 810 may be consecutive without gaps (as illustrated in FIGS. 8A and 8B). In some other aspects, the constituent control regions 810 be separated in time by a time gap (not shown). In such aspects, the time gap between the constituent control regions 810 may be configured and/or indicated by the control configuration. In some aspects, the constituent control regions 810 may each be located in a same slot, in different slots, and or in a combination of the same slots and different slots (e.g., N constituent regions with a subset of the N constituent regions per slot).

When the constituent control region 810 are configured to be located in different slots (e.g., as shown by slot i and slot j in FIGS. 8A and 8B), in some aspects, the control configuration may indicate which slot is the firstly occurring slot of the aggregate control region. When the constituent control region 810 are configured to be located in different slots(e.g., as shown by slot i and slot j in FIGS. 8A and 8B), in some other aspects, the aggregate control region may begin during a specific slot, such as a slot having an index that is a multiple of a fixed number and/or the search space may indicate a duration of the aggregate control region in slots.

In the example 800, a UE (e.g., UE 120) may use the control configuration to calculate, determine, and/or identify a configuration for a PDCCH candidate 815, including frequency location and/or starting locations. For example, when the constituent control regions 810 are on different slots (e.g., slot i and slot j), the PDCCH candidate 815 locations may be the same for the constituent control region 810a and the constituent control region 810b. In such aspects, the UE may not use the slot index as an input to calculate and/or determine the frequency locations for each slot. In some other aspects, the UE 120 may use a same slot index (e.g., “i”) to as an input to calculate and/or determine the frequency locations for each slot. For example, the UE may use the slot index for slot i to calculate the frequency location for slot i and slot j which may result in the frequency location being the same for both constituent control region 810a and constituent control region 810b. When the constituent control regions 810 are on a same slot (e.g., slot k), the PDCCH candidate 815 locations may be the same for the constituent control region 810a and the constituent control region 810b.

In the example 805, a UE (e.g., UE 120) may use the control configuration to calculate, determine, and/or identify a configuration for a PDCCH candidate 815, including frequency location and/or starting locations. For example, when the constituent control regions 810 are on different slots (e.g., slot i and slot j), the PDCCH candidate 815 locations may be different for the constituent control region 810a and the constituent control region 810b. In such aspects, the UE may not use the corresponding slot index as an input to calculate and/or determine the frequency locations for each slot. In some other aspects, the control configuration may explicitly indicate the PDCCH candidate frequency locations. When the constituent control regions 810 are on a same slot (e.g., slot k), the PDCCH candidate 815 locations may be different for the constituent control region 810a and the constituent control region 810b. For example, the control configuration may include an explicit configuration for each constituent control region 810. In some other aspects, the UE 120 may determine the frequency locations using a constituent region index indicated by the control configuration. In some other aspects, the UE 120 may determine the frequency locations by calculating a frequency location of the PDCCH candidate 815 for the first constituent control region 810a (e.g., using the constituent control region index) and may identify and/or calculate a frequency location of the PDCCH candidate 815 for the second constituent control region 810b using a hopping factor. For example, the UE may identify a frequency location of the PDCCH candidate 815 for the second constituent control region 810b using a frequency value that is relative to the frequency location of the PDCCH candidate 815 for the first constituent control region 810a.

In some aspects, the quantity of resources occupied by an aggregation level may vary relative to the quantity of constituent control regions 810. For example, an aggregation level 1 (AL1) including two constituent regions may include twice as many resources as an AL1 including a single constituent region. In such aspects, the quantity of CCEs in which the UE may perform channel estimation may increase. In one example, a maximum quantity of CCEs that the UE monitors may change relative to the quantity of constituent control regions 810. For example, a maximum quantity of CCEs may increase if a quantity of constituent control regions 810 is increased. In a second example, a maximum quantity of CCEs that the UE monitors may not change relative to the quantity of constituent control regions 810. In such examples, a network node may scale a quantity of aggregation levels to accommodate the increased quantity of control regions such that a total quantity of CCEs remains the same. For example, the UE may be configured to perform channel estimation on four AL1 PDCCH candidates and four aggregation level 16 (AL16) PDCCH candidates each associated with a single control region. When implementing aggregated control regions, in the example of the aggregate control region including two constituent control regions, the channel estimation may be scaled such that a total quantity of CCEs remains. Thus, in the example above, the UE may be configured to perform channel estimation on two AL1 PDCCH candidates and two AL16 PDCCH candidates each associated with a two constituent control regions. In a third example, a maximum quantity of CCEs that the UE monitors may change relative to the quantity of constituent control regions 810 when the constituent control regions 810 occur in different slots and/or a maximum quantity of CCEs that the UE monitors may not change relative to the quantity of constituent control regions 810 when the constituent control regions 810 occur in a same slot.

In some aspects, the quantity of resources occupied by an aggregation level may be fixed relative to the quantity of constituent control regions 810. In such aspects, some aggregation levels may not be monitored when multiple constituent control regions 810 are combined. For example, the UE may ignore (e.g., refrain from monitoring for) PDCCH candidates associated with these aggregation levels. In some other examples, the control configuration may not include candidates associated with these aggregation levels.

As indicated above, FIGS. 8A and 8B are provided as examples. Other examples may differ from what is described with respect to FIGS. 8A and 8B.

FIG. 9 is a diagram illustrating an example process 900 performed, for example, at a UE or an apparatus of a UE, in accordance with the present disclosure. Example process 900 is an example where the apparatus or the UE (e.g., UE 120) performs operations associated with combined regions for control information monitoring.

As shown in FIG. 9, in some aspects, process 900 may include receiving a control configuration that indicates one or more control regions associated with an aggregate control region and that indicates a quantity of the one or more control regions associated with the aggregate control region (block 910). For example, the UE (e.g., using reception component 1102 and/or communication manager 1106, depicted in FIG. 11) may receive a control configuration that indicates one or more control regions associated with an aggregate control region and that indicates a quantity of the one or more control regions associated with the aggregate control region, as described above.

As further shown in FIG. 9, in some aspects, process 900 may include monitoring, via the aggregate control region, for a downlink control transmission that is rate-matched over the one or more control regions (block 920). For example, the UE (e.g., using communication manager 1106, depicted in FIG. 11) may monitor, via the aggregate control region, for a downlink control transmission that is rate-matched over the one or more control regions, as described above.

Process 900 may include additional aspects, such as any single aspect or any combination of aspects described below and/or in connection with one or more other processes described elsewhere herein.

In a first aspect, the quantity of the one or more control regions associated with the aggregate control region includes a quantity of instances of each control region of the one of more control regions.

In a second aspect, alone or in combination with the first aspect, the quantity of the one or more control regions associated with the aggregate control region includes a total quantity of control regions.

In a third aspect, alone or in combination with one or more of the first and second aspects, the control configuration includes an aggregation indication that indicates whether control region aggregation is enabled and that indicates that the quantity of the one or more control regions associated with the aggregate control region includes more than one control region.

In a fourth aspect, alone or in combination with one or more of the first through third aspects, each control region of the one or more control regions associated with the aggregate control region is associated with a set of one or more time resources and a set of one or more frequency resources.

In a fifth aspect, alone or in combination with one or more of the first through fourth aspects, the control configuration indicates an index associated with each control region of the one or more control regions associated with the aggregate control region.

In a sixth aspect, alone or in combination with one or more of the first through fifth aspects, the aggregate control region comprises the one or more control regions.

In a seventh aspect, alone or in combination with one or more of the first through sixth aspects, the one or more control regions are contiguous in a time domain.

In an eighth aspect, alone or in combination with one or more of the first through seventh aspects, the control configuration indicates a time gap between a first control region of the one or more control regions and a second control region of the one or more control regions.

In a ninth aspect, alone or in combination with one or more of the first through eighth aspects, monitoring for the downlink control transmission comprises monitoring for the downlink control transmission during a time resource, wherein the time resource includes each of the one or more control regions.

In a tenth aspect, alone or in combination with one or more of the first through ninth aspects, monitoring for the downlink control transmission comprises monitoring for the downlink control transmission during a first time resource and a second time resource, wherein the first time resource and the second time resource each include at least one control region of the one or more control regions.

In an eleventh aspect, alone or in combination with one or more of the first through tenth aspects, monitoring for the downlink control transmission comprises monitoring for the downlink control transmission during a first time resource and a second time resource, wherein the first time resource and the second time resource each include at least one control region of the one or more control regions, and at least one of the first time resource or the second time resource includes two or more control regions.

In a twelfth aspect, alone or in combination with one or more of the first through eleventh aspects, the control configuration indicates a firstly occurring time resource of a set of consecutive time resources that includes at least one control region of the one or more control regions.

In a thirteenth aspect, alone or in combination with one or more of the first through twelfth aspects, the control configuration indicates a plurality of time resource indices corresponding to a set of time resources, each time resource of the set of time resources including at least one control region of the one or more control regions.

In a fourteenth aspect, alone or in combination with one or more of the first through thirteenth aspects, the downlink control transmission is associated with a set of one or more control channel candidates.

In a fifteenth aspect, alone or in combination with one or more of the first through fourteenth aspects, process 900 includes calculating, using a time resource index of a firstly occurring time resource of a plurality of time resources each including at least one control region of the one or more control regions, a hash function for a plurality of a control channel candidates corresponding to the aggregate control region.

In a sixteenth aspect, alone or in combination with one or more of the first through fifteenth aspects, monitoring for the downlink control transmission comprises monitoring, via a first frequency resource during a first time resource, for a first control channel candidate associated with a first control region of the one or more control regions, and monitoring, via the first frequency resource during a second time resource, for a second control channel candidate associated with a second control region of the one or more control regions.

In a seventeenth aspect, alone or in combination with one or more of the first through sixteenth aspects, process 900 includes calculating, independently from a time resource index, a hash function for a plurality of a control channel candidates corresponding to the aggregate control region.

In an eighteenth aspect, alone or in combination with one or more of the first through seventeenth aspects, process 900 includes calculating a hash function for each control channel candidate of a plurality of control channel candidates corresponding to the aggregate control region using a time resource index corresponding to each control channel candidate.

In a nineteenth aspect, alone or in combination with one or more of the first through eighteenth aspects, the control configuration indicates a set of frequency resources for each control region of the one or more control regions.

In a twentieth aspect, alone or in combination with one or more of the first through nineteenth aspects, monitoring for the downlink control transmission comprises monitoring, via a first frequency resource during a first time resource, for a first control channel candidate associated with a first control region of the one or more control regions, and monitoring, via a second frequency resource during a second time resource, for a second control channel candidate associated with a second control region of the one or more control regions.

In a twenty-first aspect, alone or in combination with one or more of the first through twentieth aspects, monitoring for the downlink control transmission comprises monitoring, via a frequency resource during a time resource, for a first control channel candidate associated with a first control region of the one or more control regions, and for a second control channel candidate associated with a second control region of the one or more control regions.

In a twenty-second aspect, alone or in combination with one or more of the first through twenty-first aspects, monitoring for the downlink control transmission comprises monitoring, via a first frequency resource during a time resource, for a first control channel candidate associated with a first control region of the one or more control regions, and monitoring, via a second frequency resource during the time resource, for a second control channel candidate associated with a second control region of the one or more control regions.

In a twenty-third aspect, alone or in combination with one or more of the first through twenty-second aspects, the control configuration indicates the first frequency resource and the second frequency resource.

In a twenty-fourth aspect, alone or in combination with one or more of the first through twenty-third aspects, process 900 includes calculating, using an index associated with the first control region, a hash function for the first control channel candidate that indicates the first frequency resource, and calculating, using an index associated with the second control region, a hash function for the second control channel candidate that indicates the second frequency resource.

In a twenty-fifth aspect, alone or in combination with one or more of the first through twenty-fourth aspects, process 900 includes calculating, using an index associated with the first control region, a hash function for the first control channel candidate that indicates the first frequency resource, and identifying the second frequency resource according to a frequency hopping factor applied to the first frequency resource.

In a twenty-sixth aspect, alone or in combination with one or more of the first through twenty-fifth aspects, process 900 includes performing a channel estimation procedure, wherein each control region is associated with a corresponding quantity of time-frequency resources, and a total quantity of time-frequency resources over which the UE is enabled to perform the channel estimation procedure is linearly correlated with the quantity of the one of more control regions.

In a twenty-seventh aspect, alone or in combination with one or more of the first through twenty-sixth aspects, the one or more control regions are monitored via two or more time resources.

In a twenty-eighth aspect, alone or in combination with one or more of the first through twenty-seventh aspects, process 900 includes performing a channel estimation procedure, wherein each control region is associated with a subset of a total quantity of time-frequency resources over which the UE is enabled to perform the channel estimation procedure, and the total quantity of time-frequency resources is fixed.

In a twenty-ninth aspect, alone or in combination with one or more of the first through twenty-eighth aspects, the one or more control regions are associated with a single time resource.

In a thirtieth aspect, alone or in combination with one or more of the first through twenty-ninth aspects, the one or more control regions associated with the aggregate control region are associated with an aggregation level, the method further comprising refraining from monitoring control regions associated with one or more other aggregation levels.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network node or an apparatus of a network node, in accordance with the present disclosure. Example process 1000 is an example where the apparatus or the network node (e.g., network node 110) performs operations associated with combined regions for control information monitoring.

As shown in FIG. 10, in some aspects, process 1000 may include transmitting a control configuration that indicates one or more control regions associated with an aggregate control region and that indicates a quantity of the one or more control regions associated with the aggregate control region (block 1010). For example, the network node (e.g., using transmission component 1204 and/or communication manager 1206, depicted in FIG. 12) may transmit a control configuration that indicates one or more control regions associated with an aggregate control region and that indicates a quantity of the one or more control regions associated with the aggregate control region, as described above.

As further shown in FIG. 10, in some aspects, process 1000 may include transmitting, via the aggregate control region, a downlink control transmission that is rate-matched over the one or more control regions (block 1020). For example, the network node (e.g., using transmission component 1204 and/or communication manager 1206, depicted in FIG. 12) may transmit, via the aggregate control region, a downlink control transmission that is rate-matched over the one or more control regions, as described above.

Process 1000 may include additional aspects, such as any single aspect or any combination of aspects described below and/or in connection with one or more other processes described elsewhere herein.

In a first aspect, the quantity of the one or more control regions associated with the aggregate control region includes a quantity of instances of each control region of the one of more control regions.

In a second aspect, alone or in combination with the first aspect, the quantity of the one or more control regions associated with the aggregate control region includes a total quantity of control regions.

In a third aspect, alone or in combination with one or more of the first and second aspects, the control configuration includes an aggregation indication that indicates whether control region aggregation is enabled and that indicates that the quantity of the one or more control regions associated with the aggregate control region includes more than one control region.

In a fourth aspect, alone or in combination with one or more of the first through third aspects, each control region of the one or more control regions associated with the aggregate control region is associated with a set of one or more time resources and a set of one or more frequency resources.

In a fifth aspect, alone or in combination with one or more of the first through fourth aspects, the control configuration indicates an index associated with each control region of the one or more control regions associated with the aggregate control region.

In a sixth aspect, alone or in combination with one or more of the first through fifth aspects, the aggregate control region comprises the one or more control regions.

In a seventh aspect, alone or in combination with one or more of the first through sixth aspects, the one or more control regions are contiguous in a time domain.

In an eighth aspect, alone or in combination with one or more of the first through seventh aspects, the control configuration indicates a time gap between a first control region of the one or more control regions and a second control region of the one or more control regions.

In a ninth aspect, alone or in combination with one or more of the first through eighth aspects, transmitting the downlink control transmission comprises transmitting the downlink control transmission during a time resource, wherein the time resource includes each of the one or more control regions.

In a tenth aspect, alone or in combination with one or more of the first through ninth aspects, monitoring for the downlink control transmission comprises transmitting the downlink control transmission during a first time resource and a second time resource, wherein the first time resource and the second time resource each include at least one control region of the one or more control regions.

In an eleventh aspect, alone or in combination with one or more of the first through tenth aspects, monitoring for the downlink control transmission comprises transmitting the downlink control transmission during a first time resource and a second time resource, wherein the first time resource and the second time resource each include at least one control region of the one or more control regions, and at least one of the first time resource or the second time resource includes two or more control regions.

In a twelfth aspect, alone or in combination with one or more of the first through eleventh aspects, the control configuration indicates a firstly occurring time resource of a set of consecutive time resources that includes at least one control region of the one or more control regions.

In a thirteenth aspect, alone or in combination with one or more of the first through twelfth aspects, the control configuration indicates a plurality of time resource indices corresponding to a set of time resources, each time resource of the set of time resources including at least one control region of the one or more control regions.

In a fourteenth aspect, alone or in combination with one or more of the first through thirteenth aspects, process 1000 includes rate-matching the downlink control transmission is associated with a set of one or more control channel candidates.

In a fifteenth aspect, alone or in combination with one or more of the first through fourteenth aspects, transmitting the downlink control transmission comprises transmitting, via a first frequency resource during a first time resource, a first portion of the downlink control transmission associated with a first control region of the one or more control regions, and transmitting, via the first frequency resource during a second time resource, a second portion of the downlink control transmission associated with a second control region of the one or more control regions.

In a sixteenth aspect, alone or in combination with one or more of the first through fifteenth aspects, the control configuration indicates a set of frequency resources for each control region of the one or more control regions.

In a seventeenth aspect, alone or in combination with one or more of the first through sixteenth aspects, transmitting the downlink control transmission comprises transmitting, via a first frequency resource during a first time resource, a first portion of the downlink control transmission associated with a first control region of the one or more control regions, and transmitting, via a second frequency resource during a second time resource, a second portion of the downlink control transmission associated with a second control region of the one or more control regions.

In an eighteenth aspect, alone or in combination with one or more of the first through seventeenth aspects, transmitting the downlink control transmission comprises transmitting, via a frequency resource during a time resource, a first portion of the downlink control transmission associated with a first control region of the one or more control regions, and a second portion of the downlink control transmission associated with a second control region of the one or more control regions.

In a nineteenth aspect, alone or in combination with one or more of the first through eighteenth aspects, transmitting the downlink control transmission comprises transmitting, via a first frequency resource during a time resource, a first portion of the downlink control transmission associated with a first control region of the one or more control regions, and transmitting, via a second frequency resource during the time resource, a second portion of the downlink control transmission associated with a second control region of the one or more control regions.

In a twentieth aspect, alone or in combination with one or more of the first through nineteenth aspects, the control configuration indicates the first frequency resource and the second frequency resource.

In a twenty-first aspect, alone or in combination with one or more of the first through twentieth aspects, process 1000 includes the first frequency resource is associated with an index of the first control region, and the second frequency resource is associated with an index of the second control region.

In a twenty-second aspect, alone or in combination with one or more of the first through twenty-first aspects, process 1000 includes the first frequency resource is associated with an index of the first control region, and the second frequency resource is associated with a frequency hopping factor applied to the first frequency resource.

In a twenty-third aspect, alone or in combination with one or more of the first through twenty-second aspects, process 1000 includes transmitting channel estimation information via a total quantity of time-frequency resources, wherein each control region is associated with a corresponding quantity of time-frequency resources, and the total quantity of time-frequency resources is linearly correlated with the quantity of the one of more control regions.

In a twenty-fourth aspect, alone or in combination with one or more of the first through twenty-third aspects, the one or more control regions are transmitted via two or more time resources.

In a twenty-fifth aspect, alone or in combination with one or more of the first through twenty-fourth aspects, process 1000 includes transmitting channel estimation information via a total quantity of time-frequency resources, wherein each control region is associated with a subset of the total quantity of time-frequency resources, and the total quantity of time-frequency resources is fixed.

In a twenty-sixth aspect, alone or in combination with one or more of the first through twenty-fifth aspects, the one or more control regions are associated with a single time resource.

In a twenty-seventh aspect, alone or in combination with one or more of the first through twenty-sixth aspects, the one or more control regions associated with the aggregate control region are associated with an aggregation level, the method further comprising refraining from transmitting control regions associated one or more other aggregation levels.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE, or a UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104. The communication manager 1106 may be included in, or implemented via, a processing system (for example, the processing system 140 described in connection with FIG. 1) of the UE.

In some aspects, the apparatus 1100 may be configured to perform one or more operations described herein in connection with FIGS. 7-8. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the UE described in connection with FIG. 1. Additionally, or alternatively, one or more components shown in FIG. 11 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications, and may provide the processed signals to the one or more other components of the apparatus 1100. In some aspects, the reception component 1102 may include one or more components of the UE described above in connection with FIG. 1, such as a radio, one or more RF chains, one or more transceivers, or one or more modems, each of which may in turn be coupled with one or more antennas of the UE.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications, and may transmit the processed signals to the apparatus 1108. In some aspects, the transmission component 1104 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1104 may be co-located with the reception component 1102.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive a control configuration that indicates one or more control regions associated with an aggregate control region and that indicates a quantity of the one or more control regions associated with the aggregate control region. The communication manager 1106 may monitor, via the aggregate control region, for a downlink control transmission that is rate-matched over the one or more control regions.

The communication manager 1106 may monitor for the downlink control transmission during a time resource, wherein the time resource includes each of the one or more control regions.

The communication manager 1106 may monitor for the downlink control transmission during a first time resource and a second time resource, wherein the first time resource and the second time resource each include at least one control region of the one or more control regions.

The communication manager 1106 may monitor for the downlink control transmission during a first time resource and a second time resource, wherein the first time resource and the second time resource each include at least one control region of the one or more control regions, and at least one of the first time resource or the second time resource includes two or more control regions.

The communication manager 1106 may calculate, using a time resource index of a firstly occurring time resource of a plurality of time resources each including at least one control region of the one or more control regions, a hash function for a plurality of a control channel candidates corresponding to the aggregate control region.

The communication manager 1106 may monitor, via a first frequency resource during a first time resource, for a first control channel candidate associated with a first control region of the one or more control regions. The communication manager 1106 may monitor, via the first frequency resource during a second time resource, for a second control channel candidate associated with a second control region of the one or more control regions.

The communication manager 1106 may calculate, independently from a time resource index, a hash function for a plurality of a control channel candidates corresponding to the aggregate control region.

The communication manager 1106 may calculate a hash function for each control channel candidate of a plurality of control channel candidates corresponding to the aggregate control region using a time resource index corresponding to each control channel candidate.

The communication manager 1106 may monitor, via a first frequency resource during a first time resource, for a first control channel candidate associated with a first control region of the one or more control regions. The communication manager 1106 may monitor, via a second frequency resource during a second time resource, for a second control channel candidate associated with a second control region of the one or more control regions.

The communication manager 1106 may monitor, via a frequency resource during a time resource, for a first control channel candidate associated with a first control region of the one or more control regions, and for a second control channel candidate associated with a second control region of the one or more control regions.

The communication manager 1106 may monitor, via a first frequency resource during a time resource, for a first control channel candidate associated with a first control region of the one or more control regions. The communication manager 1106 may monitor, via a second frequency resource during the time resource, for a second control channel candidate associated with a second control region of the one or more control regions.

The communication manager 1106 may calculate, using an index associated with the first control region, a hash function for the first control channel candidate that indicates the first frequency resource.

The communication manager 1106 may calculate, using an index associated with the second control region, a hash function for the second control channel candidate that indicates the second frequency resource.

The communication manager 1106 may calculate, using an index associated with the first control region, a hash function for the first control channel candidate that indicates the first frequency resource.

The communication manager 1106 may identify the second frequency resource according to a frequency hopping factor applied to the first frequency resource.

The communication manager 1106 may perform a channel estimation procedure, wherein each control region is associated with a corresponding quantity of time-frequency resources, and a total quantity of time-frequency resources over which the UE is enabled to perform the channel estimation procedure is linearly correlated with the quantity of the one of more control regions.

The communication manager 1106 may perform a channel estimation procedure, wherein each control region is associated with a subset of a total quantity of time-frequency resources over which the UE is enabled to perform the channel estimation procedure, and the total quantity of time-frequency resources is fixed.

The communication manager 1106 may refrain from monitoring control regions associated with one or more other aggregation levels.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network node, or a network node may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 155 described in connection with FIG. 1. As shown, the apparatus 1200 may communicate with another apparatus 1208, such as a UE or a network node (such as a CU, a DU, an RU, or a base station), using the reception component 1202 and the transmission component 1204. The communication manager 1206 may be included in, or implemented via, a processing system (for example, the processing system 145 described in connection with FIG. 1) of the network node.

In some aspects, the apparatus 1200 may be configured to perform one or more operations described herein in connection with FIGS. 7-8. Additionally, or alternatively, the apparatus 1200 may be configured to perform one or more processes described herein, such as process 1000 of FIG. 10, or a combination thereof. In some aspects, the apparatus 1200 and/or one or more components shown in FIG. 12 may include one or more components of the network node described in connection with FIG. 1. Additionally, or alternatively, one or more components shown in FIG. 12 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications, and may provide the processed signals to the one or more other components of the apparatus 1200. In some aspects, the reception component 1202 may include one or more components of the network node described above in connection with FIG. 1, such as a radio, one or more RF chains, one or more transceivers, or one or more modems, each of which may in turn be coupled with one or more antennas of the network node. In some aspects, the reception component 1202 and/or the transmission component 1204 may include or may be included in a network interface. The network interface may be configured to obtain and/or output signals for the apparatus 1200 via one or more communications links, such as a backhaul link, a midhaul link, and/or a fronthaul link.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications, and may transmit the processed signals to the apparatus 1208. In some aspects, the transmission component 1204 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1204 may be co-located with the reception component 1202.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The transmission component 1204 may transmit a control configuration that indicates one or more control regions associated with an aggregate control region and that indicates a quantity of the one or more control regions associated with the aggregate control region. The transmission component 1204 may transmit, via the aggregate control region, a downlink control transmission that is rate-matched over the one or more control regions.

The transmission component 1204 may transmit the downlink control transmission during a time resource, wherein the time resource includes each of the one or more control regions.

The transmission component 1204 may transmit the downlink control transmission during a first time resource and a second time resource, wherein the first time resource and the second time resource each include at least one control region of the one or more control regions.

The transmission component 1204 may transmit the downlink control transmission during a first time resource and a second time resource, wherein the first time resource and the second time resource each include at least one control region of the one or more control regions, and at least one of the first time resource or the second time resource includes two or more control regions.

The communication manager 1206 may rate-match the downlink control transmission across a set of one or more control channel candidates.

The transmission component 1204 may transmit, via a first frequency resource during a first time resource, a first portion of the downlink control transmission associated with a first control region of the one or more control regions. The transmission component 1204 may transmit, via the first frequency resource during a second time resource, a second portion of the downlink control transmission associated with a second control region of the one or more control regions.

The transmission component 1204 may transmit, via a first frequency resource during a first time resource, a first portion of the downlink control transmission associated with a first control region of the one or more control regions. The transmission component 1204 may transmit, via a second frequency resource during a second time resource, a second portion of the downlink control transmission associated with a second control region of the one or more control regions.

The transmission component 1204 may transmit, via a frequency resource during a time resource, a first portion of the downlink control transmission associated with a first control region of the one or more control regions, and a second portion of the downlink control transmission associated with a second control region of the one or more control regions.

The transmission component 1204 may transmit, via a first frequency resource during a time resource, a first portion of the downlink control transmission associated with a first control region of the one or more control regions. The transmission component 1204 may transmit, via a second frequency resource during the time resource, a second portion of the downlink control transmission associated with a second control region of the one or more control regions.

The transmission component 1204 may transmit channel estimation information via a total quantity of time-frequency resources, wherein each control region is associated with a corresponding quantity of time-frequency resources, and the total quantity of time-frequency resources is linearly correlated with the quantity of the one of more control regions.

The transmission component 1204 may transmit channel estimation information via a total quantity of time-frequency resources, wherein each control region is associated with a subset of the total quantity of time-frequency resources, and the total quantity of time-frequency resources is fixed.

The communication manager 1206 may refrain from transmitting control regions associated one or more other aggregation levels.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:
Aspect 1: A method of wireless communication performed by a user equipment (UE), comprising: receiving a control configuration that indicates one or more control regions associated with an aggregate control region and that indicates a quantity of the one or more control regions associated with the aggregate control region; and monitoring, via the aggregate control region, for a downlink control transmission that is rate-matched over the one or more control regions.
Aspect 2: The method of Aspect 1, wherein the quantity of the one or more control regions associated with the aggregate control region includes a quantity of instances of each control region of the one of more control regions.
Aspect 3: The method of any of Aspects 1-2, wherein the quantity of the one or more control regions associated with the aggregate control region includes a total quantity of control regions.
Aspect 4: The method of any of Aspects 1-3, wherein the control configuration includes an aggregation indication that indicates whether control region aggregation is enabled and that indicates that the quantity of the one or more control regions associated with the aggregate control region includes more than one control region.
Aspect 5: The method of any of Aspects 1-4, wherein each control region of the one or more control regions associated with the aggregate control region is associated with a set of one or more time resources and a set of one or more frequency resources.
Aspect 6: The method of any of Aspects 1-5, wherein the control configuration indicates an index associated with each control region of the one or more control regions associated with the aggregate control region.
Aspect 7: The method of any of Aspects 1-6, wherein the aggregate control region comprises the one or more control regions.
Aspect 8: The method of any of Aspects 1-7, wherein the one or more control regions are contiguous in a time domain.
Aspect 9: The method of any of Aspects 1-7, wherein the control configuration indicates a time gap between a first control region of the one or more control regions and a second control region of the one or more control regions.
Aspect 10: The method of any of Aspects 1-9, wherein monitoring for the downlink control transmission comprises: monitoring for the downlink control transmission during a time resource, wherein the time resource includes each of the one or more control regions.
Aspect 11: The method of any of Aspects 1-9, wherein monitoring for the downlink control transmission comprises: monitoring for the downlink control transmission during a first time resource and a second time resource, wherein the first time resource and the second time resource each include at least one control region of the one or more control regions.
Aspect 12: The method of any of Aspects 1-9, wherein monitoring for the downlink control transmission comprises: monitoring for the downlink control transmission during a first time resource and a second time resource, wherein the first time resource and the second time resource each include at least one control region of the one or more control regions, and at least one of the first time resource or the second time resource includes two or more control regions.
Aspect 13: The method of any of Aspects 1-12, wherein the control configuration indicates a firstly occurring time resource of a set of consecutive time resources that includes at least one control region of the one or more control regions.
Aspect 14: The method of any of Aspects 1-13, wherein the control configuration indicates a plurality of time resource indices corresponding to a set of time resources, each time resource of the set of time resources including at least one control region of the one or more control regions.
Aspect 15: The method of any of Aspects 1-14, wherein the downlink control transmission is associated with a set of one or more control channel candidates.
Aspect 16: The method of any of Aspects 1-15, further comprising: calculating, using a time resource index of a firstly occurring time resource of a plurality of time resources each including at least one control region of the one or more control regions, a hash function for a plurality of a control channel candidates corresponding to the aggregate control region.
Aspect 17: The method of any of Aspects 1-16, wherein monitoring for the downlink control transmission comprises: monitoring, via a first frequency resource during a first time resource, for a first control channel candidate associated with a first control region of the one or more control regions; and monitoring, via the first frequency resource during a second time resource, for a second control channel candidate associated with a second control region of the one or more control regions.
Aspect 18: The method of any of Aspects 1-15, further comprising: calculating, independently from a time resource index, a hash function for a plurality of a control channel candidates corresponding to the aggregate control region.
Aspect 19: The method of any of Aspects 1-15, further comprising: calculating a hash function for each control channel candidate of a plurality of control channel candidates corresponding to the aggregate control region using a time resource index corresponding to each control channel candidate.
Aspect 20: The method of any of Aspects 1-19, wherein the control configuration indicates a set of frequency resources for each control region of the one or more control regions.
Aspect 21: The method of any of Aspects 1-20, wherein monitoring for the downlink control transmission comprises: monitoring, via a first frequency resource during a first time resource, for a first control channel candidate associated with a first control region of the one or more control regions; and monitoring, via a second frequency resource during a second time resource, for a second control channel candidate associated with a second control region of the one or more control regions.
Aspect 22: The method of any of Aspects 1-20, wherein monitoring for the downlink control transmission comprises: monitoring, via a frequency resource during a time resource, for a first control channel candidate associated with a first control region of the one or more control regions, and for a second control channel candidate associated with a second control region of the one or more control regions.
Aspect 23: The method of any of Aspects 1-20, wherein monitoring for the downlink control transmission comprises: monitoring, via a first frequency resource during a time resource, for a first control channel candidate associated with a first control region of the one or more control regions; and monitoring, via a second frequency resource during the time resource, for a second control channel candidate associated with a second control region of the one or more control regions.
Aspect 24: The method of Aspect 23, wherein the control configuration indicates the first frequency resource and the second frequency resource.
Aspect 25: The method of Aspect 23, further comprising: calculating, using an index associated with the first control region, a hash function for the first control channel candidate that indicates the first frequency resource; and calculating, using an index associated with the second control region, a hash function for the second control channel candidate that indicates the second frequency resource.
Aspect 26: The method of Aspect 23, further comprising: calculating, using an index associated with the first control region, a hash function for the first control channel candidate that indicates the first frequency resource; and identifying the second frequency resource according to a frequency hopping factor applied to the first frequency resource.
Aspect 27: The method of any of Aspects 1-26, further comprising: performing a channel estimation procedure, wherein each control region is associated with a corresponding quantity of time-frequency resources, and a total quantity of time-frequency resources over which the UE is enabled to perform the channel estimation procedure is linearly correlated with the quantity of the one of more control regions.
Aspect 28: The method of Aspect 27, wherein the one or more control regions are monitored via two or more time resources.
Aspect 29: The method of any of Aspects 1-26, further comprising: performing a channel estimation procedure, wherein each control region is associated with a subset of a total quantity of time-frequency resources over which the UE is enabled to perform the channel estimation procedure, and the total quantity of time-frequency resources is fixed.
Aspect 30: The method of Aspect 29, wherein the one or more control regions are associated with a single time resource.
Aspect 31: The method of any of Aspects 1-26, wherein the one or more control regions associated with the aggregate control region are associated with an aggregation level, the method further comprising: refraining from monitoring control regions associated with one or more other aggregation levels.
Aspect 32: A method of wireless communication performed by a network node, comprising: transmitting a control configuration that indicates one or more control regions associated with an aggregate control region and that indicates a quantity of the one or more control regions associated with the aggregate control region; and transmitting, via the aggregate control region, a downlink control transmission that is rate-matched over the one or more control regions.
Aspect 33: The method of Aspect 32, wherein the quantity of the one or more control regions associated with the aggregate control region includes a quantity of instances of each control region of the one of more control regions.
Aspect 34: The method of any of Aspects 32-33, wherein the quantity of the one or more control regions associated with the aggregate control region includes a total quantity of control regions.
Aspect 35: The method of any of Aspects 32-34, wherein the control configuration includes an aggregation indication that indicates whether control region aggregation is enabled and that indicates that the quantity of the one or more control regions associated with the aggregate control region includes more than one control region.
Aspect 36: The method of any of Aspects 32-35, wherein each control region of the one or more control regions associated with the aggregate control region is associated with a set of one or more time resources and a set of one or more frequency resources.
Aspect 37: The method of any of Aspects 32-36, wherein the control configuration indicates an index associated with each control region of the one or more control regions associated with the aggregate control region.
Aspect 38: The method of any of Aspects 32-37, wherein the aggregate control region comprises the one or more control regions.
Aspect 39: The method of any of Aspects 32-38, wherein the one or more control regions are contiguous in a time domain.
Aspect 40: The method of any of Aspects 32-38, wherein the control configuration indicates a time gap between a first control region of the one or more control regions and a second control region of the one or more control regions.
Aspect 41: The method of any of Aspects 32-40, wherein transmitting the downlink control transmission comprises: transmitting the downlink control transmission during a time resource, wherein the time resource includes each of the one or more control regions.
Aspect 42: The method of any of Aspects 32-40, wherein monitoring for the downlink control transmission comprises: transmitting the downlink control transmission during a first time resource and a second time resource, wherein the first time resource and the second time resource each include at least one control region of the one or more control regions.
Aspect 43: The method of any of Aspects 32-40, wherein monitoring for the downlink control transmission comprises: transmitting the downlink control transmission during a first time resource and a second time resource, wherein the first time resource and the second time resource each include at least one control region of the one or more control regions, and at least one of the first time resource or the second time resource includes two or more control regions.
Aspect 44: The method of any of Aspects 32-43, wherein the control configuration indicates a firstly occurring time resource of a set of consecutive time resources that includes at least one control region of the one or more control regions.
Aspect 45: The method of any of Aspects 32-44, wherein the control configuration indicates a plurality of time resource indices corresponding to a set of time resources, each time resource of the set of time resources including at least one control region of the one or more control regions.
Aspect 46: The method of any of Aspects 32-45, further comprising: rate-matching the downlink control transmission across a set of one or more control channel candidates.
Aspect 47: The method of any of Aspects 32-46, wherein transmitting the downlink control transmission comprises: transmitting, via a first frequency resource during a first time resource, a first portion of the downlink control transmission associated with a first control region of the one or more control regions; and transmitting, via the first frequency resource during a second time resource, a second portion of the downlink control transmission associated with a second control region of the one or more control regions.
Aspect 48: The method of any of Aspects 32-47, wherein the control configuration indicates a set of frequency resources for each control region of the one or more control regions.
Aspect 49: The method of any of Aspects 32-46, wherein transmitting the downlink control transmission comprises: transmitting, via a first frequency resource during a first time resource, a first portion of the downlink control transmission associated with a first control region of the one or more control regions; and transmitting, via a second frequency resource during a second time resource, a second portion of the downlink control transmission associated with a second control region of the one or more control regions.
Aspect 50: The method of any of Aspects 32-46, wherein transmitting the downlink control transmission comprises: transmitting, via a frequency resource during a time resource, a first portion of the downlink control transmission associated with a first control region of the one or more control regions, and a second portion of the downlink control transmission associated with a second control region of the one or more control regions.
Aspect 51: The method of any of Aspects 32-46, wherein transmitting the downlink control transmission comprises: transmitting, via a first frequency resource during a time resource, a first portion of the downlink control transmission associated with a first control region of the one or more control regions; and transmitting, via a second frequency resource during the time resource, a second portion of the downlink control transmission associated with a second control region of the one or more control regions.
Aspect 52: The method of Aspect 51, wherein the control configuration indicates the first frequency resource and the second frequency resource.
Aspect 53: The method of Aspect 51, wherein: the first frequency resource is associated with an index of the first control region, and the second frequency resource is associated with an index of the second control region.
Aspect 54: The method of Aspect 51, wherein: the first frequency resource is associated with an index of the first control region, and the second frequency resource is associated with a frequency hopping factor applied to the first frequency resource.
Aspect 55: The method of any of Aspects 32-54, further comprising: transmitting channel estimation information via a total quantity of time-frequency resources, wherein each control region is associated with a corresponding quantity of time-frequency resources, and the total quantity of time-frequency resources is linearly correlated with the quantity of the one of more control regions.
Aspect 56: The method of Aspect 55, wherein the one or more control regions are transmitted via two or more time resources.
Aspect 57: The method of any of Aspects 32-54, further comprising: transmitting channel estimation information via a total quantity of time-frequency resources, wherein each control region is associated with a subset of the total quantity of time-frequency resources, and the total quantity of time-frequency resources is fixed.
Aspect 58: The method of Aspect 57, wherein the one or more control regions are associated with a single time resource.
Aspect 59: The method of any of Aspects 32-54, wherein the one or more control regions associated with the aggregate control region are associated with an aggregation level, the method further comprising: refraining from transmitting control regions associated one or more other aggregation levels.
Aspect 60: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-59.
Aspect 61: An apparatus for wireless communication at a device, the apparatus comprising one or more memories and one or more processors coupled to the one or more memories, the one or more processors configured to cause the device to perform the method of one or more of Aspects 1-59.
Aspect 62: An apparatus for wireless communication, the apparatus comprising at least one means for performing the method of one or more of Aspects 1-59.
Aspect 63: A non-transitory computer-readable medium storing code for wireless communication, the code comprising instructions executable by one or more processors to perform the method of one or more of Aspects 1-59.
Aspect 64: A non-transitory computer-readable medium storing a set of instructions for wireless communication, the set of instructions comprising one or more instructions that, when executed by one or more processors of a device, cause the device to perform the method of one or more of Aspects 1-59.
Aspect 65: A device for wireless communication, the device comprising a processing system that includes one or more processors and one or more memories coupled with the one or more processors, the processing system configured to cause the device to perform the method of one or more of Aspects 1-59.
Aspect 66: An apparatus for wireless communication at a device, the apparatus comprising one or more memories and one or more processors coupled to the one or more memories, the one or more processors individually or collectively configured to cause the device to perform the method of one or more of Aspects 1-59.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a +b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, configured to cause the UE to:
receive a control configuration that indicates one or more control regions associated with an aggregate control region and that indicates a quantity of the one or more control regions associated with the aggregate control region; and monitor, via the aggregate control region, for a downlink control transmission that is rate-matched over the one or more control regions.

2. The apparatus of claim 1, wherein the quantity of the one or more control regions associated with the aggregate control region includes a quantity of instances of each control region of the one of more control regions.

3. The apparatus of claim 1, wherein the quantity of the one or more control regions associated with the aggregate control region includes a total quantity of control regions.

4. The apparatus of claim 1, wherein the one or more control regions are contiguous in a time domain.

5. The apparatus of claim 1, wherein the control configuration indicates a time gap between a first control region of the one or more control regions and a second control region of the one or more control regions.

6. The apparatus of claim 1, wherein the one or more processors, to cause the UE to monitor for the downlink control transmission, are configured to cause the UE to:
monitor for the downlink control transmission during a time resource, wherein the time resource includes each of the one or more control regions.

7. The apparatus of claim 1, wherein the one or more processors, to cause the UE to monitor for the downlink control transmission, are configured to cause the UE to: monitor for the downlink control transmission during a first time resource and a second time resource, wherein the first time resource and the second time resource each include at least one control region of the one or more control regions.

8. The apparatus of claim 1, wherein the one or more processors, to cause the UE to monitor for the downlink control transmission, are configured to cause the UE to: monitor for the downlink control transmission during a first time resource and a second time resource, wherein the first time resource and the second time resource each include at least one control region of the one or more control regions, and at least one of the first time resource or the second time resource includes two or more control regions.

9. An apparatus for wireless communication at a network node, comprising:
one or more memories; and
one or more processors, coupled to the one or more memories, configured to cause the network node to:
transmit a control configuration that indicates one or more control regions associated with an aggregate control region and that indicates a quantity of the one or more control regions associated with the aggregate control region; and transmit, via the aggregate control region, a downlink control transmission that is rate-matched over the one or more control regions.

10. The apparatus of claim 9, wherein the one or more processors, to cause the network node to transmit the downlink control transmission, are configured to cause the network node to:
transmit the downlink control transmission during a time resource, wherein the time resource includes each of the one or more control regions.

11. The apparatus of claim 9, wherein the one or more processors, to cause the network node to monitor for the downlink control transmission, are configured to cause the network node to:
transmit the downlink control transmission during a first time resource and a second time resource, wherein the first time resource and the second time resource each include at least one control region of the one or more control regions.

12. The apparatus of claim 9, wherein the one or more processors, to cause the network node to monitor for the downlink control transmission, are configured to cause the network node to:
transmit the downlink control transmission during a first time resource and a second time resource, wherein the first time resource and the second time resource each include at least one control region of the one or more control regions, and at least one of the first time resource or the second time resource includes two or more control regions.

13. The apparatus of claim 9, wherein the control configuration indicates a firstly occurring time resource of a set of consecutive time resources that includes at least one control region of the one or more control regions.

14. The apparatus of claim 9, wherein the control configuration indicates a plurality of time resource indices corresponding to a set of time resources, each time resource of the set of time resources including at least one control region of the one or more control regions.

15. A method of wireless communication performed by a user equipment (UE), comprising:
receiving a control configuration that indicates one or more control regions associated with an aggregate control region and that indicates a quantity of the one or more control regions associated with the aggregate control region; and
monitoring, via the aggregate control region, for a downlink control transmission that is rate-matched over the one or more control regions.

16. The method of claim 15, further comprising:
calculating, using a time resource index of a firstly occurring time resource of a plurality of time resources each including at least one control region of the one or more control regions, a hash function for a plurality of a control channel candidates corresponding to the aggregate control region.

17. The method of claim 15, wherein monitoring for the downlink control transmission comprises:
monitoring, via a first frequency resource during a first time resource, for a first control channel candidate associated with a first control region of the one or more control regions; and
monitoring, via the first frequency resource during a second time resource, for a second control channel candidate associated with a second control region of the one or more control regions.

18. The method of claim 15, further comprising:
calculating, independently from a time resource index, a hash function for a plurality of a control channel candidates corresponding to the aggregate control region.

19. The method of claim 15, further comprising:
calculating a hash function for each control channel candidate of a plurality of control channel candidates corresponding to the aggregate control region using a time resource index corresponding to each control channel candidate.

20. The method of claim 15, wherein monitoring for the downlink control transmission comprises:
monitoring, via a first frequency resource during a first time resource, for a first control channel candidate associated with a first control region of the one or more control regions; and
monitoring, via a second frequency resource during a second time resource, for a second control channel candidate associated with a second control region of the one or more control regions.

21. The method of claim 15, wherein monitoring for the downlink control transmission comprises:
monitoring, via a frequency resource during a time resource, for a first control channel candidate associated with a first control region of the one or more control regions, and for a second control channel candidate associated with a second control region of the one or more control regions.

22. The method of claim 15, wherein monitoring for the downlink control transmission comprises:
monitoring, via a first frequency resource during a time resource, for a first control channel candidate associated with a first control region of the one or more control regions; and
monitoring, via a second frequency resource during the time resource, for a second control channel candidate associated with a second control region of the one or more control regions.

23. The method of claim 15, further comprising:
performing a channel estimation procedure, wherein each control region is associated with a corresponding quantity of time-frequency resources, and a total quantity of time-frequency resources over which the UE is enabled to perform the channel estimation procedure is linearly correlated with the quantity of the one of more control regions.

24. The method of claim 15, further comprising:
performing a channel estimation procedure, wherein each control region is associated with a subset of a total quantity of time-frequency resources over which the UE is enabled to perform the channel estimation procedure, and the total quantity of time-frequency resources is fixed.

25. A method of wireless communication performed by a network node, comprising:
transmitting a control configuration that indicates one or more control regions associated with an aggregate control region and that indicates a quantity of the one or more control regions associated with the aggregate control region; and
transmitting, via the aggregate control region, a downlink control transmission that is rate-matched over the one or more control regions.

26. The method of claim 25, wherein the downlink control transmission is associated with a set of one or more control channel candidates.

27. The method of claim 25, wherein transmitting the downlink control transmission comprises:
transmitting, via a first frequency resource during a first time resource, a first control channel candidate associated with a first control region of the one or more control regions; and
transmitting, via the first frequency resource during a second time resource, a second control channel candidate associated with a second control region of the one or more control regions.

28. The method of claim 25, wherein transmitting the downlink control transmission comprises:
transmitting, via a first frequency resource during a first time resource, a first control channel candidate associated with a first control region of the one or more control regions; and
transmitting, via a second frequency resource during a second time resource, a second control channel candidate associated with a second control region of the one or more control regions.

29. The method of claim 25, wherein transmitting the downlink control transmission comprises:
transmitting, via a frequency resource during a time resource, a first control channel candidate associated with a first control region of the one or more control regions, and a second control channel candidate associated with a second control region of the one or more control regions.

30. The method of claim 25, wherein transmitting the downlink control transmission comprises:
transmitting, via a first frequency resource during a time resource, a first control channel candidate associated with a first control region of the one or more control regions; and
transmitting, via a second frequency resource during the time resource, a second control channel candidate associated with a second control region of the one or more control regions.
